(19) United States
(12) Patent Application Publication
(10) Pub. No.: US 2016/0071033 A1
(43) Pub. Date: Mar. 10, 2016

(54) METHODS AND APPARATUS FOR TRACKING CONSTRUCTION MATERIAL DELIVERY

(71) Applicant: Truckast, Inc., Beverly Hills, CA (US)

(72) Inventors: Todd Davis, Dana Point, CA (US); Christopher Heiser, Anaheim, CA (US); Matt Brinker, Denver, CO (US)

(21) Appl. No.: 14/848,105

(22) Filed: Sep. 8, 2015

Related U.S. Application Data
(60) Provisional application No. 62/048,140, filed on Sep. 9, 2014.

(51) Int. Cl. G06Q 10/06; G06Q 50/08; G06Q 10/08

(52) U.S. Cl. CPC G06Q 10/0631; G06Q 10/0833; G06Q 50/08

(57) ABSTRACT

Methods and apparatus for tracking delivery of construction materials from a supplier facility to a jobsite. An ordering module enables customers to place and modify orders before or while delivery occurs. Ticket information for loads shipped from the supplier facility is used to provide up-to-date information about the status of the construction material delivery and to provide an electronic audit trail of activities during the delivery timeline. A social stream integrated with the application enables notifications to be sent to users associated with an order and enables users to add posts with comments including pictures to provide enriched real-time communication between various parties during the delivery.

### RELATED APPLICATIONS

This application claims priority under 35 U.S.C. §119(e) to U.S. Provisional Patent Application Ser. No. 62/048,140, filed Sep. 9, 2014 and entitled “Methods and Apparatus for Tracking Construction Material Delivery,” which is herein incorporated by reference in its entirety.

### BACKGROUND

As part of a construction job, construction materials such as concrete, asphalt, lumber, shingles, bricks, etc. are often delivered from a production or storage facility to a construction jobsite at a scheduled time using one or more delivery vehicles. To place an order for a certain quantity and type of construction material to be delivered, a customer (e.g., a general contractor for the construction project) typically calls or sends a fax to the construction material provider (referred to as a “provider” herein) with the order. The provider enters the order information into their system and generates one or more paper tickets to be delivered with the construction material to the jobsite at a specified time.

### SUMMARY

Methods and apparatus for tracking delivery of construction materials from a supplier facility to a jobsite are described. An ordering module enables customers to place and modify orders before or while delivery occurs. Ticket information for loads shipped from the supplier facility is used to provide up-to-date information about the status of the construction material delivery and to provide an electronic audit trail of activities during the delivery timeline. A social stream integrated with the application enables notifications to be sent to users associated with an order and enables users to add posts with comments including pictures to provide enriched real-time communication between various parties during the delivery.

Some embodiments are directed to a method of tracking the delivery of construction material from a supplier location to a construction jobsite. The method comprises determining a forecasted schedule for delivery of the construction material, receiving, by a cloud-based storage device, an electronic ticket indicating a delivery status of a load of the construction material to the construction jobsite, and updating the forecasted schedule based, at least in part, on information associated with the electronic ticket.

Some embodiments are directed to at least one computer comprising at least one computer processor programmed to receive a request for updated data from a client device for an application executing on the client device, determine, based at least in part, on the request, an application-specific script associated with the application, query, using instructions in the application-specific script, at least one cloud-based storage device for the updated data, receive the updated data from the at least one cloud-based storage device, and transmit the updated data to the client device.

Some embodiments are directed to a method for providing an audit trail of a construction material delivery process from a storage facility to a jobsite. The method comprises, receiving, when a load of construction material leaves the storage facility, an electronic ticket for the load, storing on at least one network-connected storage device, information associated with the electronic ticket, wherein the information includes a first timestamp indicating when the load left the storage facility, receiving, when the load arrives at the jobsite, updated information for the electronic ticket, wherein the updated information includes a second timestamp indicating when the load arrived at the jobsite, creating an audit trail of the construction material delivery based at least, in part, on the first timestamp and the second timestamp for the electronic ticket.

Some embodiments are directed to a non-transitory computer readable storage medium encoded with a plurality of instructions, that, when executed by at least one computer processor performs a method. The method comprises determining a forecasted schedule for delivery of construction material, receiving, by a cloud-based storage device, an electronic ticket indicating a delivery status of a load of the construction material to the construction jobsite, and updating the forecasted schedule based, at least in part, on information associated with the electronic ticket.

Some embodiments are directed to a method of updating in real-time, an order for construction material being delivered to a job site. The method comprises storing, by at least one storage device order information for the order, receiving, at a server computer, a request to change at least one aspect of the order, notifying a producer of the construction material about the request, updating the information for the order stored by the at least one storage device after receiving a response from the producer of the construction material, and sending a notification to at least one client device associated with the order in response to updating the information for the order.

It should be appreciated that all combinations of the foregoing concepts and additional concepts discussed in greater detail below (provided that such concepts are not mutually inconsistent) are contemplated as being part of the inventive subject matter disclosed herein.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a schematic of an illustrative computing architecture that may be used in accordance with some embodiments;

FIG. 2 is a flowchart of a process for responding to requests for data from a client device using a novel platform in accordance with some embodiments;

FIG. 3 is a flowchart of a process for processing incoming data using components of the architecture of FIG. 1;

FIG. 4 is a flowchart of a process for extracting data into entities and sub-entities for an application in accordance with some embodiments;

FIG. 5 is a flowchart of a forecasting loads process in accordance with some embodiments;

FIG. 6 is a flowchart of a tickets and key status times process in accordance with some embodiments;

FIG. 7 is a flowchart of a process for adjusting a planned on job time in accordance with some embodiments;

FIG. 8 is a flowchart of a process for determining slack for an order in accordance with some embodiments;

FIG. 9 is a flowchart of a process for determining information about a current status of an order in accordance with some embodiments;

FIG. 10 is a flowchart of a process for providing a late truck notification in accordance with some embodiments;

FIG. 11 is a flowchart of a process for creating and organizing posts for a social stream in accordance with some embodiments;

FIG. 12 is a flowchart of a process for determining an order pour speed in accordance with some embodiments;

FIG. 13 is a flowchart of a process for aggregating information about a completed order in accordance with some embodiments;

FIG. 14 is a screenshot of a user interface element for displaying market summary information in accordance with some embodiments;

FIG. 15 is a flowchart of a process for updating the data displayed on the user interface element of FIG. 14;

FIG. 16 is a screenshot of a user interface element for displaying order information in accordance with some embodiments;

FIG. 17 is a flowchart of a process for updating the data displayed on the user interface element of FIG. 16;

FIGS. 18A and 18B are screenshots of a user interface elements for displaying social stream information in accordance with some embodiments;

FIG. 19 is a flowchart of a process for updating the data displayed on the user interface element of FIG. 18B;

FIG. 20 is a flowchart of a process for creating social stream data in accordance with some embodiments;

FIGS. 21A and 21B are screenshot of a user interface elements for displaying information for pending and in-progress orders, respectively, in accordance with some embodiments;

FIG. 22 is a flowchart of a process for updating the data displayed on the user interface element of FIG. 21B;

FIG. 23 is a flowchart of a process for determining in-progress data in accordance with some embodiments;

FIG. 24 is a screenshot of a user interface element for displaying volume delivery stage information in accordance with some embodiments;

FIG. 25 is a flowchart of a process for updating the data displayed on the user interface element of FIG. 24;

FIG. 26 is a screenshot of a user interface element for displaying pour speed timeline information in accordance with some embodiments;

FIG. 27 is a flowchart of a process for updating the data displayed on the user interface element of FIG. 26;

FIG. 28 is a screenshot of a user interface element for displaying trucks on a job information in accordance with some embodiments;

FIG. 29 is a flowchart of a process for updating the data displayed on the user interface element of FIG. 28;

FIG. 30 is a screenshot of a user interface element for displaying order summary information in accordance with some embodiments; and

FIG. 31 is an exemplary computer system that may be used to implement some embodiments.

### DETAILED DESCRIPTION

The inventors have recognized and appreciated that conventional systems for tracking the delivery of construction materials may be improved through the use of a cloud-based platform that provides an interface between source data associated with a provider and one or more client applications configured to use and/or update at least some of the source data. The client application(s) may be used to provide up-to-date and/or real-time information to construction personnel regarding the delivery of construction material to a jobsite. Some illustrative embodiments describing a representative architecture and use of a cloud-based platform by client applications are described herein with respect to data that pertains to the construction industry. However, it should be appreciated that a cloud-based platform used in accordance with some embodiments may alternatively be used to process data corresponding to other industries, and embodiments are not limited in this respect.

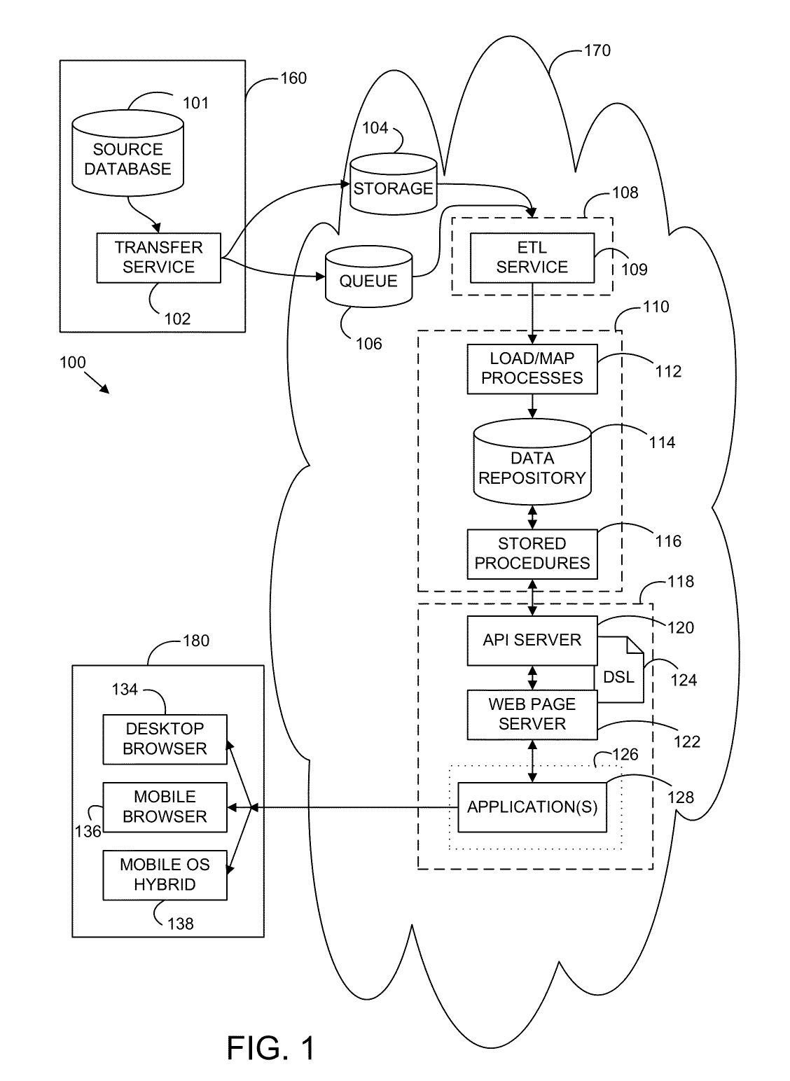

FIG. 1 illustrates a computer architecture 100 that may be used in accordance with some embodiments. Architecture 100 includes components distributed as provider-side components 160, cloud components 170, and client-side components 180. As discussed in more detail below, although some components may be described as being located at the provider 160, in alternative embodiments, at least some of these components may be located in the cloud 170 and/or at least some of the components located in the cloud 170 may alternatively be located at the provider 160. For example, in some embodiments, provider database 101 and transfer service 102, described in more detail below, may reside at least partially in the cloud 170.

### Provider-Side Components

Provider-side components 160 include provider database 101 and transfer service 102. Source data associated with a provider's operations may be persisted in provider database 101. For example, provider database 101 may include information related to orders for construction material delivery, information related to the location of delivery vehicles, or any other suitable information associated with activities of the provider. Any suitable type or size of storage may be used as provider database 101. For example, provider database may be an Oracle database, an SQL database, or any other type of database configured to store information associated with the provider. Because the provider database may be of any suitable type and can include any number of storage devices, embodiments may be configured to be used with an existing data storage infrastructure of a provider without substantial modification, as described in further detail below.

To enable source data in provider database 101 to be utilized by a cloud-based platform, at least some of the source data may be transferred to cloud storage 104 using transfer service 102. Transfer service 102 may be implemented as a process or set of processes that execute on one or more computers at the provider, and that interface with provider database 101. Transfer service 102 is responsible for accessing source data in provider database 101, packaging the data in a manner such that it can be transferred to cloud storage 104, and sending the packaged data via a secure channel to cloud storage 104. In some embodiments, transfer service 102 is a configurable extensible markup language (XML)-based tool that includes a plurality of configuration libraries, one or more of which can be selected during installation of the transfer service 102 at the provider site. Each of the configuration libraries may include a plurality of configuration files used to extract particular source data from the provider database 101 and to package the data in an appropriate format for transfer and/or storage by cloud storage 104.

As discussed above, any suitable provider database type and/or configuration may be used with embodiments. To extract data from provider database 101 to provide to cloud storage 104, an installer of transfer service 102 may need only to select appropriate settings (e.g., by selecting a particular configuration library or by using another suitable technique) to properly configure transfer service 102 to perform the data extraction. Additionally, for provider database types or configurations that do not have a corresponding configuration library, a new configuration library may be created to enable transfer service 102 to extract appropriate data from those provider databases.

In some embodiments, transfer service 102 may be configured to accommodate a multitude of source data formats, configurable through an XML-based domain-specific language (DSL). Transfer service 102 may be configured to return any suitable amount of data from provider database 101, and embodiments are not limited in this respect. For example, in some embodiments, transfer service 102 may be configured to return snapshots of only recent data, thereby reducing bandwidth requirements and processing resources. In some embodiments, transfer service 102 may be configured to perform one or more additional functions prior to transmitting the data to cloud storage 104. For example, transfer service may be configured to modify (e.g., clean) and/or reformat at least some of the data prior to transferring the data to cloud storage 104.

Data selected by transfer service 102 may be packaged in any suitable format for transferring the data to cloud storage 104. In some embodiments, the data may be packaged in accordance with the JavaScript Object Notation (JSON) standard to transmit the data from the provider database 101 to cloud storage 104, though it should be appreciated that the data may be packaged in any other suitable way. For example, the data may be packaged as XML documents that are securely transferred to cloud storage 104.

In some embodiments, the data extracted from provider database 101 by transfer service 102 may be encrypted or otherwise transformed to facilitate the secure transfer of the data to cloud storage 104. Any suitable encryption technique may be used to encrypt the data and embodiments are not limited in this respect. Additionally, the network connection established between transfer service 102 and cloud storage 104 may be a secure connection established based on one or more authentication procedures, examples of which are known in the art.

Any suitable type or organization of cloud storage 104 may be used, and embodiments are not limited in this respect. For example, cloud storage provided by cloud storage vendors such as Amazon, Google, and IBM, or any other suitable cloud storage vendor may be used. In other embodiments, cloud storage 104 may be hosted locally by the provider rather than being hosted by a cloud storage vendor. In one implementation, Simple Storage Service (S3) provided by Amazon Web Service may be used for cloud storage 104.

In addition to transferring data to cloud storage 104, information describing the transferred data may be stored in cloud queue 106. Information in cloud queue 106 may be stored using any suitable format, and embodiments are not limited in this respect. For example, in some embodiments, cloud queue 106 may be configured to store information about the transferred data as one or more messages or records. In one implementation, Amazon Simple Queue Service (SQS) provided by Amazon Web Service may be used to implement cloud queue 106.

### Cloud Components

Cloud 170 may include one or more “compute instances,” which are physical or, more typically, virtual machines in the cloud computing infrastructure that include software for performing one or more tasks. For example, each instance may be a virtual server that executes one or more applications. As shown in FIG. 1, cloud 170 includes three compute instances including data loading compute instance 108, data layer compute instance 110, and web server compute instance 118. It should be appreciated, however, that cloud 170 may include any suitable number of compute instances (including a single instance or multiple instances for performing a single function), and embodiments are not limited in this respect. Additionally, any suitable technology including, but not limited to, the EC2 service provided by Amazon Web Services, may be used to implement compute instances in cloud 170.

As shown, cloud 170 includes data loading compute instance 108 on which Extraction, Translation, Load (ETL) service 109 resides. ETL service 109 is configured to monitor cloud queue 106 for an indication that new data has been written to cloud storage 104. As discussed above, as new data is transferred to cloud storage 104, corresponding information may be written to cloud queue 106 indicating that the new data has been transferred and stored in cloud storage 104. For example, when a new record is added to cloud queue 106, the creation of the new record may provide an indication to ETL service 109 that new data is available in cloud storage 104 for processing by ETL service 109. After determining that new data is available for processing, ETL service 109 is configured to retrieve the new data from cloud storage 104 and initiate a process of storing the data in data repository 114 by leveraging one or more load processes resident on data layer compute instance 110, as discussed in more detail below.

As shown, cloud 170 includes data layer compute instance 110 with which data repository 114 is associated, and on which stored procedures 116 associated with data repository 114 reside. For example, data layer compute instance 110 includes one or more loading/mapping processes 112 that facilitate the transfer, formatting, and processing of data retrieved from cloud storage 104 by ETL service 109 prior to storage of the retrieved data in data repository 114.

After retrieving data from cloud storage 104, ETL service 109 transfers the retrieved data to loading/mapping processes 112, which process the data. Any suitable loading/mapping processes may be used, and embodiments are not limited in this respect. For example, loading/mapping processes 112 may include one or more general mapping or loading processes that operate on data received from all providers or a subset of providers. Alternatively or additionally, loading/mapping processes 112 may include one or more customized mapping or loading processes configured for processing data received from one or more particular providers. Loading/mapping processes 112 accept the data from ETL service 109, process the data in accordance with particular rules included in a process being applied, and deposit (i.e., load) the processed data in data repository 114.

Data repository 114 may include any suitable type or amount of storage for storing processed data received from loading/mapping processes 112. In one implementation, data repository 114 comprises a relational database management system (RDMS) such as an SQL Server, and loading/mapping processes 112 are implemented as T-SQL stored procedures. It should be appreciated, however, that other data structures and procedures may alternatively be used for data repository 114 and/or loading/mapping processes 112, and embodiments are not limited in this respect. For example, data repository 114 may include any suitable cloud database solution including, but not limited to, DynamoDB, which is a nosq1 service provided by Amazon Web Services. Data stored in data repository 114 may be used to produce meaningful and presentable visual reports to end users, as discussed in more detail below.

As shown, data layer compute instance 110 of architecture 100 also includes stored procedures 116, which are configured to query data stored in data repository 114 and to provide data-based logic for architecture 100. In one implementation, stored procedures 116 are implemented as T-SQL stored procedures. However, it should be appreciated that other types of procedures may alternatively be used. Examples of algorithms that may be used in accordance with stored procedures 116 are described in more detail below.

Fast application development is a valuable asset to companies that seek to have a product/market fit through tight iteration cycles. However, the growing complexity of systems makes it difficult to deliver results in a timely manner. The inventors have recognized and appreciated that programming web-based applications often requires proficiency in many different technologies including, but not limited to, ASP.NET, MVC, jQuery, Javascript, HTML, CSS, HTTP, IIS, T-SQL, SQL Server, C#, JSON, etc. However, it is often a challenge for teams of application developers to achieve proficiency in all of these technologies, though it is a requirement if the web-application solution depends on them.

Some embodiments are directed to a novel platform that simplifies the application development process by removing the requirement that developers understand all of the technologies in the application stack to create a new application. Rather, in some embodiments, application developers may be required only to understand how to create new stored procedures 116 using a platform-specific domain specific language (DSL) 124. In some embodiments, DSL 124 may be an XML-based script that enables the rapid creation of application screens for an application. By simplifying application development in this manner it is possible to achieve rapid development and rapid iteration of applications using the platform.

An illustrative platform created for use with some embodiments is called D3. The D3 platform uses a proprietary script that facilitates the construction of interfaces, and associates those interfaces with data stored in data repository 114. Web server requests from applications programmed to use the D3 platform are routed to the appropriate D3 script, and the D3 engine combines the specified data with user interface elements as defined by the page layout in each script. The D3 script emits markup that is the result of combined logic and data based on instructions found with the D3 DSL. The D3 script is designed to mask complex operations from the application programmer. For example, a single D3 command may connect to a URL, request data, download the data from data repository 114, parse the data, and injected it into a UI table to be displayed on multiple client device types—all operations an application programmer would need to spending time coding individually and connecting.

In accordance with some embodiments that use a novel platform (e.g., D3) as described above, end-to-end solutions for web and mobile applications may be authored using simple scripts by application developers who are unfamiliar with the technologies typically required for implementation, providing a benefit for iterative development, where customer feedback can be accommodated quickly and sent back to the customer for further review.

An example of how the platform can be used to speed development of applications relates to the dynamic generation of an application programming interface (API) in response to creating a new stored procedure using DSL 124. In some embodiments, once a stored procedure 116 is written, the platform may automatically produce a corresponding API 120 (e.g., a RESTful web service call) for the procedure, making the data instantly accessible over the web to users and applications with the appropriate permissions. Applications written for the platform may then request and retrieve data from data repository 114 through the generated API 120.

Returning to a description of architecture 100 shown in FIG. 1, cloud 170 also includes web services compute instance 118, on which API server 120 resides. In some embodiments, web server compute instance 118 comprises a single codebase that services API and web page requests for all applications. In other embodiments, a separate web server compute instance 118 may be configured for each producer and/or application, or multiple web server compute instances 118 may be used for a single application. For example, in some embodiments, web server compute instance 118 may be cloned in accordance with traffic volume. When requests are low, only a single instance can be used, and when traffic increases, multiple copies of the instance can be started to handle traffic from additional connections.

Web server compute instance 118 also includes web server 122. Just as API server 120 is configured to fulfill web requests for data, as discussed above, web server 122 is configured to serve web pages, which represent the various screens of an application. In some embodiments, web server 122 shares the same compute instance as API server 120, as shown in FIG. 1. In other embodiments, web server 122 may execute in a separate compute instance than API server 120, and embodiments are not limited in this respect.

As discussed above, API server 120 satisfies data requests, and web server 122 satisfies requests for web pages that include the relevant data. As an example, an application may display a screen with a pie chart depicting the productivity of a certain concrete plant. Web server 122 may issue a request to API server 120 for the relevant productivity data to display on the pie chart. Upon receiving the data from API server 120, web server 122 may package the data into a pie chart and return a web page including the pie chart to a client (e.g., clients 134, 136, and 138). Accordingly, API server 120 and web server 122 may be configured to work hand-in-hand to deliver appropriate application screens to clients on which the application is being run.

As shown, web services compute instance 118 optionally includes one or more applications configured to use at least some of the functionality described above. An example of one such application 128 called TRUCKAST, is described in further detail below. It should be appreciated, however, that TRUCKAST is merely one example of an application that may be used with embodiments, and use of other applications is also contemplated.

### Client Components

Applications and their respective screens can be delivered to one or more clients 180. Illustrative clients 180 may include, but are not limited to, desktop browsers 134, such as Internet Explorer, Firefox, Chrome, and Safari, mobile browsers 136, such as Internet Explorer Mobile, Firefox for Mobile, Chrome and Safari, and mobile OS hybrid clients 138. Examples of mobile OS hybrid clients include, but are not limited to, clients for the iOS operating system provided by Apple, Inc. (Cupertino, Calif.), and clients for the Android operating system provided by Google, Inc. (Mountain View, Calif.). Mobile hybrid clients may, for example, present the content served from the platform as discussed above, while also providing the content access to native functionality, including, but not limited to, GPS functionality, imaging functionality, and multipart file uploads.

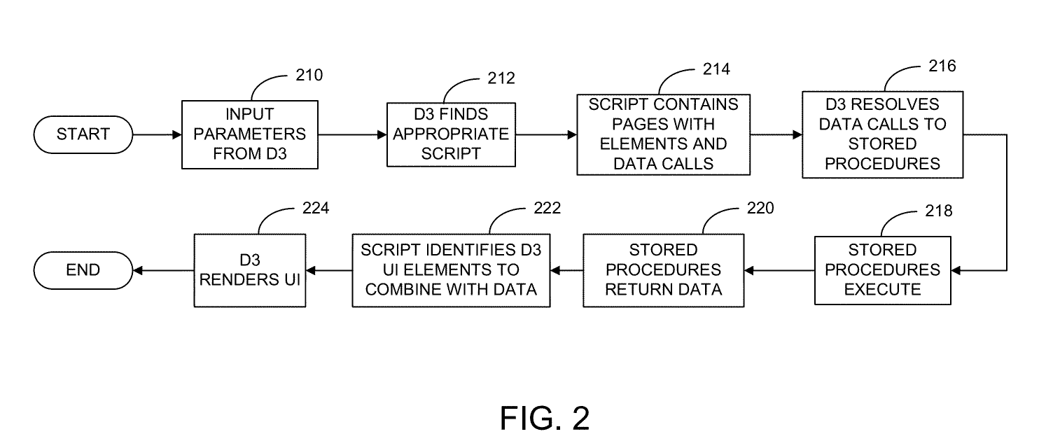

A high-level block diagram of how an application (e.g., TRUCKAST) written using the D3 platform, described above, processes a request from a client for updated data for the application is described in FIG. 2. In act 210, a request including input parameters from a D3 application is received from a client. The process then proceeds to act 212, where a D3 script identifies an appropriate application-specific script to service the request. The process then proceeds to act 214, where the application-specific script, which includes web pages with user interface elements and data calls is retrieved and interpreted. The process then proceeds to act 216, where the D3 platform resolves the data calls in the application-specific script to stored procedures, as described above. The process then proceeds to act 218, where one or more of the stored procedures is executed to query data repository 114 for particular data. The process proceeds to act 220, where the executed stored procedures return data in response to the data calls specified in the application-specific script. The process then proceeds to act 222, where the application-specific script identifies D3 user interface elements to combine with the retrieved data. The process then proceeds to act 224, where the user interface including a representation of the retrieved data is rendered by the D3 engine. The rendered user interface may then be provided to the client that initiated the request.

As discussed above, some embodiments are directed to techniques for using the illustrative cloud-based architecture 100 to provide information about the delivery of construction materials from a provider to jobsites at which the materials are consumed to client devices that present the information to users. The techniques described in more detail below relate to processes for loading incoming data (e.g., from a provider's operational system or other suitable source), aggregating data using stored procedures for an application, and providing data to a client device executing the application. Data provided to a client device may be provided in response to a request from the client application to provide particular data or may be “pushed” to the client device without receiving a request for particular data.

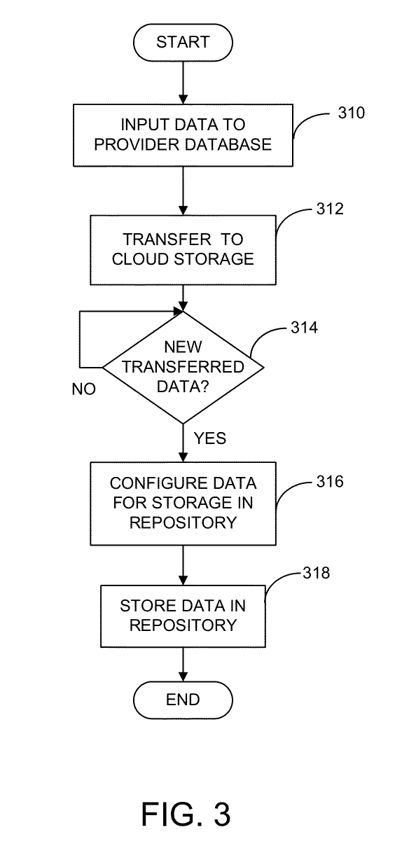

FIG. 3 shows a high-level process for loading data into data repository 114 in accordance with some embodiments. In act 310, data is input to a provider database. The data may be input in any suitable way. For example, data may be entered directly into producer database by an employee or other authorized personnel of the producer in response to a customer providing order information via fax, phone, email, etc. Alternatively, data may be entered automatically in response to receiving the data from another system. For example, some embodiments track the location of construction delivery vehicles using sensors (e.g., GPS sensors) located on the vehicles, and the location information is transmitted to a producer database where it is stored. As discussed above, any suitable type of information may be stored in a producer database, and the examples of storing order information or vehicle location information are provided above merely for illustrative purposes.

The process then proceeds to act 312, where at least some data stored in a producer database is transferred to cloud storage. For example, as discussed above, a transfer service installed and configured to interact with the producer database may, at regular or irregular intervals, extract data from producer database and transfer the extracted data to cloud storage. The transfer service may optionally package the data including, but not limited to, compressing and/or encrypting the data, and transfer the data to cloud storage. The process then proceeds to act 314, where it is determined by a component executing on the cloud platform, whether new data has been transferred to cloud storage. In accordance with the embodiment described above and illustrated in FIG. 1, an ETL service may monitor for new data transferred to cloud storage, and in response to determining that new data has been transferred, the process proceeds to act 316, where the data is configured for storage in a cloud data repository. After the data has been configured, the process proceeds to act 318, where the data is stored in the repository.

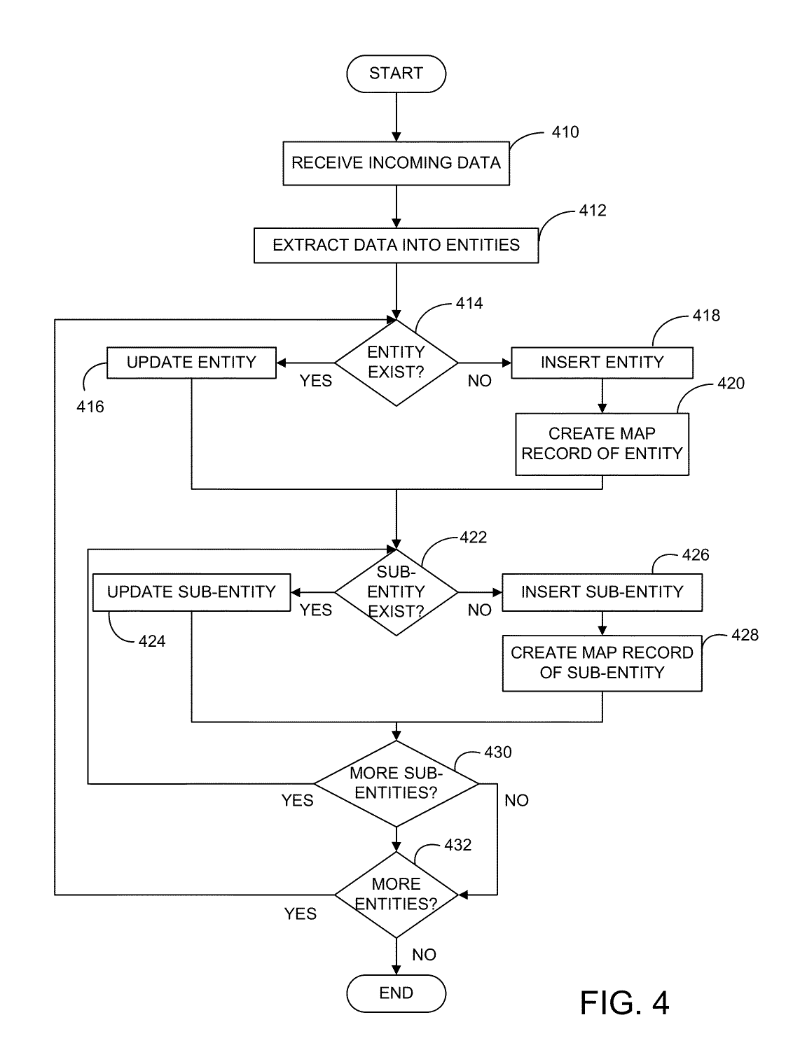

In some embodiments, incoming data is parsed based on entities that define data of interest for a particular application. The entities may have properties which are created and maintained by loading/mapping processes 112 for the entity. Entities may be associated with one or more sub-entities, although some entities may not have any sub-entities. FIG. 4 shows an illustrative process for processing incoming data based on entities/sub-entities. In accordance with some embodiments, entities may be automatically created when it is determined that a mapping for the incoming data to the entity does not exist, as discussed in more detail below.

In act 410, incoming data is received from a provider database or from any other suitable source. The process then proceeds to act 412, where the received data is extracted into entities identifying data to be tracked for a particular application. In some embodiments, data extraction into entities may be performed by ETL service 109, discussed above. The process then proceeds to act 414, where it is determined whether a data structure for an entity corresponding to at least some of the extracted data already exists in cloud 170 (e.g., if incoming data for the entity was previously received). If it is determined that a data structure for the entity has already been created for the extracted data, the process proceeds to act 416, where the data in the data structure for the entity is updated based on the extracted data.

If it is determined that a data structure for the entity does not exist, the process proceeds to act 418, where a data structure for the entity is created and data based on the extracted data is added to the newly-created data structure for the entity. To facilitate the updating of data for the entity based on subsequent incoming data, the process proceeds to act 420, where a map record of the entity is created. The map record of the entity may be used by ETL service 109 upon receiving subsequent incoming data to indicate that a data structure for entity already exists (e.g., in act 414).

The process then proceeds to act 422, where it is determined whether a data structure for a sub-entity of the entity being updated exists. In the illustrative process of FIG. 4, each entity is assumed to have at least one sub-entity. However, as discussed above, some entities may not have any sub-entities. For such entities, acts 422, 424, 426, 428, and 430 may be bypassed and after updating data for an entity, the process may proceed directly to act 432, where it is determined whether there are more entities to update based on the extracted data.

If it is determined in act 422 that a data structure for a sub-entity exists, the process proceeds to act 424, where data for the sub-entity is updated. If it is determined in act 422 that a data structure for the sub-entity does not exist, the process proceeds to act 426, where a data structure for the sub-entity is created and data based on the extracted data is added to the newly-created data structure for the sub-entity. To facilitate the updating of data for the sub-entity based on subsequent incoming data, the process proceeds to act 428, where a map record of the sub-entity is created. The map record of the sub-entity may be used by ETL service 109 upon receiving subsequent incoming data to indicate that a data structure for sub-entity already exists (e.g., in act 422).

After updating data for a sub-entity, the process proceeds to act 430, where it is determined whether the extracted data includes updated data for more sub-entities. If it is determined that the extracted data includes updated data for more sub-entities, the process returns to act 422, and the process repeats until data for all sub-entities has been updated based on the data extracted from the incoming data. If it is determined that data for all sub-entities of an entity have been updated (or if the entity does not have sub-entities, as discussed above), the process proceeds to act 432, where it is determined whether the extracted data includes updated data for additional entities. If it is determined that the extracted data includes updated data for additional entities, the process returns to act 314, and the process repeats until data for all entities has been updated based on the data extracted from the incoming data. If it is determined that all entities have been updated based on the data extracted from the incoming data, the process ends.

It should be appreciated that the extent to which entities/sub-entities may be updated based on the incoming data is dependent, at least in part, on the content of the incoming data. In some instances, the incoming data may provide sufficient data for updating all entities and sub-entities, whereas in other instances, the incoming data may provide sufficient data for updating less than all entities/sub-entities. For example, in some instances the incoming data may provide sufficient data for updating only a single entity or sub-entity. The extent to which incoming data provides sufficient data for updating entities/sub-entities does not limit embodiments.

Any suitable entities/sub-entities may be defined for data extraction in accordance with some embodiments, and the defined entities/sub-entities may be dependent on one or more applications programmed to use the extracted data. For example, the illustrative application TRUCKAST may be programmed to request data related to the status of orders for concrete delivery from a producer's facility to a jobsite where the concrete is poured for a construction project. Such an application may define the following entities/sub-entities for data extraction and loading into data repository 114:

TABLE 1
Illustrative Entities/sub-entities for TRUCKAST application

Entity: Sub-entities
Order: Plant, Customer, Job, Order Status, TakenByEmployee,
SalesmanEmployee, Customer Category
OrderItem: Order, Product, Unit
OrderSchedule: Order, OrderItem, Plant
OrderDeliveryStep: Order, DeliveryStep
Ticket: Plant, PlantLane, Customer, Job, Vehicle, DriverEmployee,
TicketStatus
TicketItem: Ticket, Product, Unit, CostUnit
TicketDeliveryStep: Ticket, DeliveryStep

The inventors have recognized that suppliers of construction materials have various forms of organization. An application (e.g., TRUCKAST) programmed in accordance with the techniques described herein may account for those various forms by using “nodes,” which represent the various levels of the supplier organization, and the entities that make up those levels. Supplier organizations may have any suitable number of node levels, and embodiments are not limited in this respect. As discussed in more detail below, access to information may be limited for particular users based on which nodes the users have access to.

Some embodiments may be configured to categorize users into two categories: internal and external. Internal users may be assigned roles that are limited based on user-defined markets for the company, and external users may be assigned to at least one customer company. An internal user may be assigned to multiple companies, and an external user may be assigned to one or more jobs. External users may be granted access to an order based on the customer they have been assigned to. When order comes in, all users with access to the customer may be granted access to the job. Access to the job may be created in any suitable way including, but not limited to, creating a record that associates the user with the job. If a user already has access to the job, no record may be created.

As discussed above, in some embodiments, nodes may be used to restrict users' access to information. For example, internal users may have their access limited by nodes they have access to, whereas external users may have access to all nodes. Nodes which a user has access to are the “permitted nodes” for that user. Additionally, external users may be limited by the jobs they have access to, whereas internal users may have access to all jobs. Jobs which a user has access to are the “permitted jobs” for that user.

### Illustrative Functionality for TRUCKAST

As discussed above, some embodiments are directed to applications designed using a platform that enables the retrieval of data aggregated on cloud-based storage, wherein the data describes information about the delivery of construction materials from a supplier facility to a jobsite. Illustrative functionality of an application called TRUCKAST, which tracks the delivery of concrete from one or more plants where the concrete is sourced to jobsites where the concrete is delivered and used, is discussed in more detail below.

For the TRUCKAST application, customers place orders for concrete using an order request form for a particular job. The order may include information about the type (e.g., brand, consistency) of concrete required, the quantity of concrete required, customer information, the location of the jobsite, the time of the first expected delivery, a desired truck spacing time, and any other suitable information about the order, such as an indication of whether the order is a firm order or a soft order. Once completed, the order request form may be transmitted to a concrete producer, where the order request is rejected, accepted, or edited by the producer. If the order request is rejected, an indication of the rejected order may be sent to the customer. If the order request is edited by the producer, the edited order request may be transmitted to the customer for acceptance of the changes. If the order request is accepted, the information in the order request may be entered into the producer's dispatch system. As discussed above in connection with architecture 100, information (e.g., order information) entered into the producer databases may be transferred to data repository 114 at regular or irregular intervals, such that stored procedures associated with applications may use the data to perform functions, examples of which are described in more detail below.

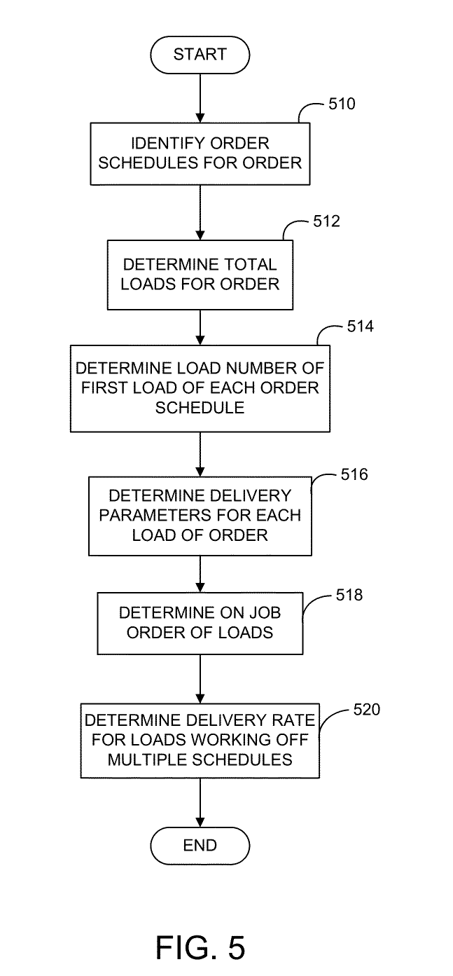

In some embodiments, functionality of an application may be implemented using one or more stored procedures, as discussed above. The stored procedure(s) for a particular function may call or reference one or more other stored procedures that perform different function(s). An application may include a set of one or more “core” stored procedures that perform basic or “core” functionality of the application and are called from several other stored procedures. Two core stored procedures for the TRUCKAST application—“Forecasting Loads” and “Tickets/Key Status Times,” are discussed in more detail below with regard to FIGS. 5-8.

FIG. 5 illustrates a process for a stored procedure called “Forecasting Loads” that determines theoretical loads for an order based on its order schedule(s). Each order for delivery of concrete to a jobsite may be associated with one or more order schedules that identify an order item (e.g., a type of concrete) and a plant from which the order item is being delivered. In act 510, all order schedules for an order are identified based on the information about the order stored in data repository 114. For example, the application may define an entity OrderSchedule, which includes the sub-entities Order, OrderItem, and Plant. Data retrieved from the data structure(s) for the OrderSchedule entity for an order may be used to identify the order schedules for that particular order.

After order schedules for an order are determined, the process proceeds to act 512, where the total number of loads for the order is determined. For example, if the order is associated with three order schedules associated with three different plants, the total number of loads for the order may be determined by adding the number of loads expected to be delivered from each of the three plants to complete the order. The number of loads to be delivered from each plant in accordance with an order schedule may be determined in any suitable way and may depend, at least in part, on producer factors such as availability of the requested construction material at the plant and the amount of construction material that can be transported from the plant using a single delivery vehicle (e.g., truck).

After determining the total number of loads for the order, the process proceeds to act 514, where a load number of the first load for each of the order schedule is determined. The process then proceeds to act 516, where delivery parameters for each load of the order are determined. Any suitable delivery parameters may be determined in act 516, and embodiments are not limited in this respect. For example, the delivery parameters may include, but are not limited to, on job time, volume, and scheduled delivery rate for each load for the order. The process then proceeds to act 518, where the on job order of the loads is determined. The process then proceeds to act 520, where the delivery rate for loads working off multiple order schedules is determined.

The forecasted load data determined using the process of FIG. 5 may be stored in data repository 114 in any suitable way for retrieval by other stored procedures configured to perform functions for tracking the delivery of construction materials from suppliers to the jobsites, as discussed in more detail below.

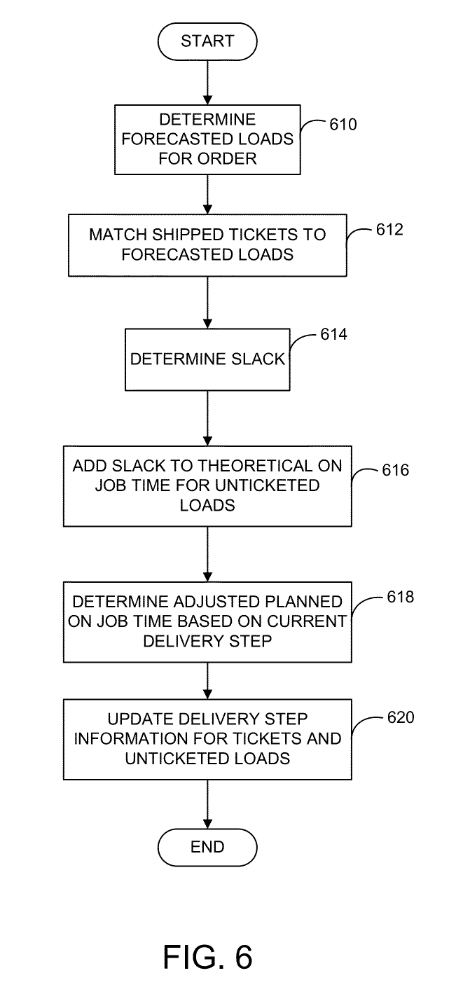

An example of a stored procedure that calls the Forecasting Loads process shown in FIG. 5 is the Tickets/Key Status Times stored procedure described below with reference to FIGS. 6-8. The Tickets/Key Status Times stored procedure calls the Forecasting Loads procedure and updates the forecasted loads information using up to date information about what is happening with the order based on tickets for the order that have been received and stored in data repository 114.

As discussed above, conventional construction material delivery systems issue paper tickets with loads as they are shipped from the supply facility to the jobsite. The paper tickets may be collected by workers at the jobsite and returned to the customer who may match them to the order that was placed. During this process, paper tickets are often lost, resulting in an incomplete picture of the construction material delivery process. Additionally, paper tickets only provide information about whether the construction material was delivered, but provide no information about whether the material was delivered on time. In accordance with some embodiments, electronic tickets for an order are stored in data repository 114 when construction material is shipped from the supply facility. Delivery status information associated with the stored tickets enables applications to track in real time the delivery of construction material to the jobsite and enables creation of an electronic audit trail detailing the construction material tracking process.

FIG. 6 shows an illustrative process for determining updated tracking information for an order based on shipped tickets for the order stored in data repository 114. In act 610, theoretical loads for an order are determined, for example, using the forecasting loads stored procedure illustrated in FIG. 5. In some embodiments, the theoretical loads for the order may be determined each time the process of FIG. 6 is executed. However, in other embodiments, the theoretical loads for an order may only be determined once (e.g., when the order is first received in data repository 114), the theoretical loads for the order may be determined periodically, or only when the order is updated by the producer or the customer. The forecasted loads for the order is used as the baseline delivery schedule for the order, and information from tickets is used to update the baseline delivery schedule to provide a real time view of how the delivery of construction material is proceeding.

After determining the forecasted loads for the order, the process proceeds to act 612, where the shipped tickets for the order stored in data repository 114 are matched to the theoretical loads determined in act 610. The shipped tickets may be matched to the theoretical loads in any suitable way. For example, each of the shipped tickets may be associated with ticket information that identifies the plant from which material was shipped, and the job associated with the ticket, and the ticket information may be used to perform the matching process between shipped tickets and forecasted loads to be shipped from particular plants. Any suitable information may be associated with tickets stored in data repository 114, and embodiments are not limited in this respect. In some embodiments, ticket information may include a plant ID, ticket number, current delivery step, timestamp of the delivery step, load size, and load type (e.g., regular load or plus load).

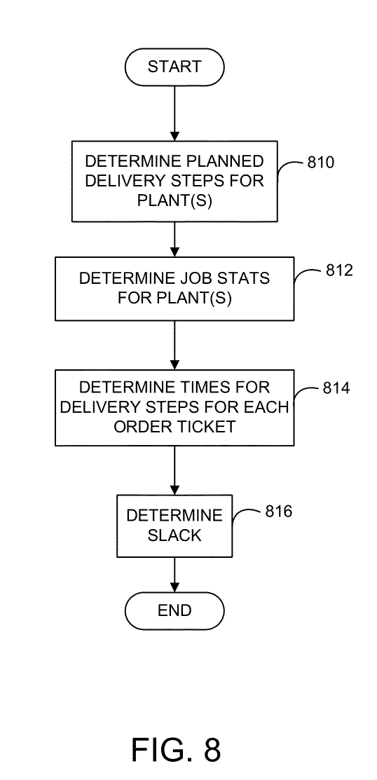

The process then proceeds to act 614 where the slack, which represents an amount of time that the order has varied from its theoretical plan, is determined. In some embodiments, the slack may be determined for the last N loads, where N is greater than 1. For example, in one implementation, the slack is determined for the last three loads, and if there hasn't been at least three loads ticketed, the first load's on job time is compared to the theoretical time to determine the slack. An illustrative process for determining the slack in accordance with some embodiments is described in further detail below with regard to FIG. 8.

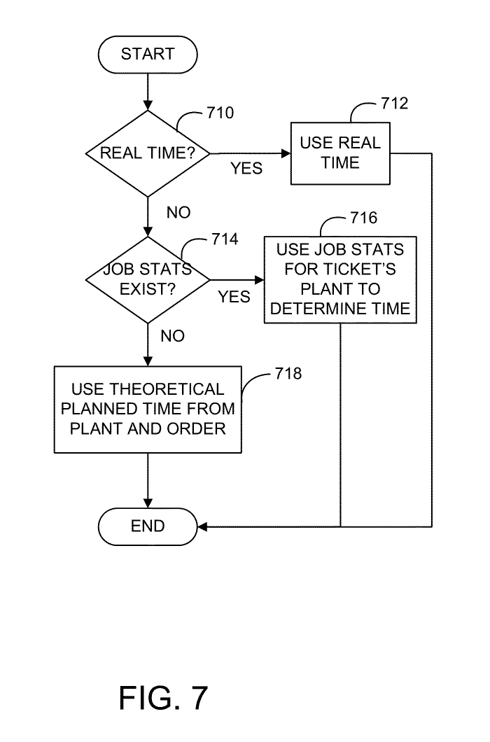

After determining the slack, the process proceeds to act 616, where the slack is added to the theoretical on job time for loads that have not yet been ticketed (e.g., loads that have not yet shipped). The process then proceeds to act 618, where an adjusted on job time is determined for tickets based on their current delivery step. For example, tickets may be associated with loads that are either in progress (i.e., the load for the ticket is being delivered, but has not yet arrived) loads that have already arrived at the jobsite, and are thus associated with a “real” on job time, being the time that the load arrived at the jobsite. An illustrative process for determining an adjusted planned on job time for in-progress or delivered tickets is describe further in detail below with regard to FIG. 7.

The process of FIG. 6 then proceeds to act 620, where delivery step information for tickets and unticketed loads is updated. For example, the theoretical on job time, begin pour time, and end pour time for tickets that do not have “real” times (e.g., because the load has not yet arrived at the jobsite) may be updated using job statistics for the order and/or plant for the ticket. An example of determining job statistics for the order/plant is discussed further in connection with FIG. 8. In some embodiments, bad data may be accounted for by making sure all timestamps appear in the order of the delivery step (e.g., begin pour timestamps must be after on job timestamps). Additional delivery step information may also be determined and/or update in act 620. For example, the on job order and end pour order for each ticket, the maximum on job order and end pour order, and/or the on job order and end pour order for tickets that don't exist yet, may be determined.

FIG. 7 shows an illustrative process for determining an adjusted planned on job time for a ticket based on a current delivery step in accordance with some embodiments. In act 710 it is determined whether an on job timestamp is associated with a real time, indicating that the load associated with the ticket has been delivered. If it is determined that the timestamp is a real time, the process proceeds to act 712, where the real time is used as the adjusted planned on job time for the ticket. If it is determined that the timestamp does not correspond to a real time (i.e., the load associated with the ticket has not yet been delivered), the process proceeds to act 714, where it is determined whether job statistics from the ticket's plant exist. An example of determining job statistics for a plant is described further below with regard to FIG. 8. If it is determined that job statistics for the ticket's plant exist, the process proceeds to act 716, where the job statistics from the ticket's plant are used to determine the adjusted planned on job time for the ticket. If it is determined that job statistics for the ticket's plant do not yet exist, the process proceeds to act 718, where the theoretical planned time for the ticket's plant and order are used to determine the adjusted planned on job time for the ticket.

FIG. 8 shows an illustrative process for determining slack for an order based on actual times for delivery steps associated with tickets of the order. In act 810, the planned delivery steps for each plant working on an order is determined based on the forecasted loads determination. The process then proceeds to act 812, where job statistics for each plant are determined. The job statistics for a plant reflect how long it is actually taking to complete each delivery step for the plant. As discussed above, the plant-specific job statistics information may be used to update on job times for tickets associated with in-progress loads or for tickets that have not yet been issued. The job statistics may be determined in any suitable way, and embodiments are not limited in this respect. For example, in some embodiments job statistics are determined based only on a particular number of recent records (e.g., the last five records).

The process of FIG. 8 then proceeds to act 814, where the actual times for delivery steps for each ticket of the order are determined. For example, the loaded time, on job time, begin pour time, and end pour time for each ticket may be determined. The process then proceeds to act 816, where the slack (e.g., in minutes) for the order is determined, as discussed above in connection with FIG. 6. For example, the actual times for the delivery steps for each ticket may be compared to the theoretical/forecasted plan for the order for the last N loads to determine the slack for the order.

In some embodiments, rather than calculating data values in response to a request to provide data, at least some data values in data repository 114 may be aggregated to provide client applications a faster response time when the data is requested. To provide data aggregation, some embodiments include aggregation stored procedures, discussed in more detail below.

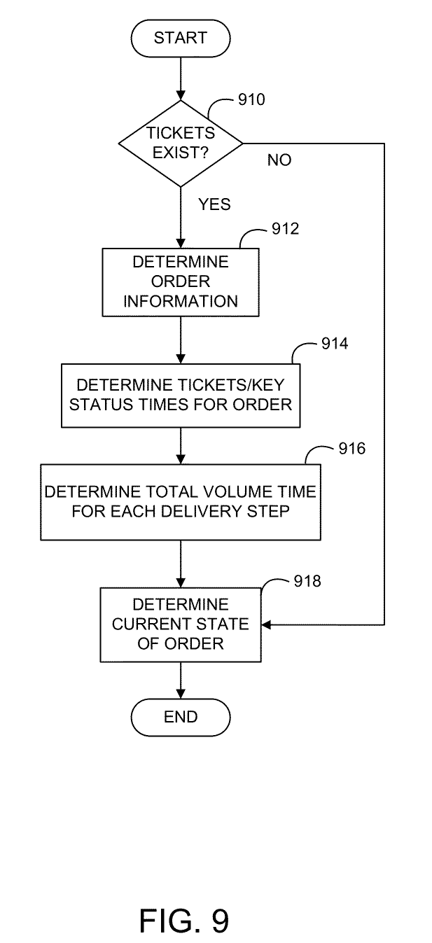

FIG. 9 shows an illustrative process for determining a current state of an order. In act 910, it is determined whether tickets exist for the order. If it is determined that no tickets exist yet for the order (e.g., because no loads have been shipped yet), the process ends. If it is determined that tickets exist for the order, the process proceeds to act 912, where order information for the order including, but not limited to, plant, customer, job, order status, delivery time, and volume, are determined. The process then proceeds to act 914, where all of the tickets and key status times for the order are determined, for example, using the processes illustrated in FIGS. 6-8. The process then proceeds to act 916, where the total volume for each delivery step is determined.

The process then proceeds to act 918, where the pour state of the order is determined. In some embodiments, the pour state of the order may be determined as follows: cancelled—order has been cancelled; pre-pour—order has been placed, but no tickets exist yet; in progress—order has been placed and tickets exist; complete—order has poured all the volume planned in the order; or on-hold—order has been placed on hold. Other pour states are also possible, and embodiments are not limited in this respect.

As particular events occur, some embodiments may be configured to perform one or more actions and/or provide or more notifications to customers alerting the customers of the occurrence of the particular event(s). For example, in some embodiments, when an order is received and information about the order is stored in data repository 114, a copy of the order may be placed in a record of an order changes table with a timestamp indicating when the order was changed. If it is the first time that the order has been received, a new order alert may be created and provided to one or more users associated with the order. If the order already has a record in the order changes table, the received order may be compared to the previous copy of the order, and one or more users associated with the order may be alerted about the changes to the order.

Another event that may trigger one or more actions is determining that a volume associated with a ticket has made the running volume for an order more than the ordered quantity at the time when the pour started. In response to determining that the ordered quantity has been exceeded, the load may be marked as a “plus load,” and a notification may optionally be sent to one or more users associated with the order.

Another event that may trigger creation and/or sending of a notification is when a ticket corresponds to a first or last load for an order. For example, if a ticket is the first load for an order, a first truck notification may be created, which will alert construction crew at the jobsite and/or other users that the first truck is on its way. If a volume associated with a ticket makes the running total for the order equal to the ordered volume, it may be determined that the ticket corresponds to the last load for the order, and a last load notification may be created, which will alert one or more users associated with the order that the last truck is on its way, and may give an authorized user the ability to modify the order if more material is needed.

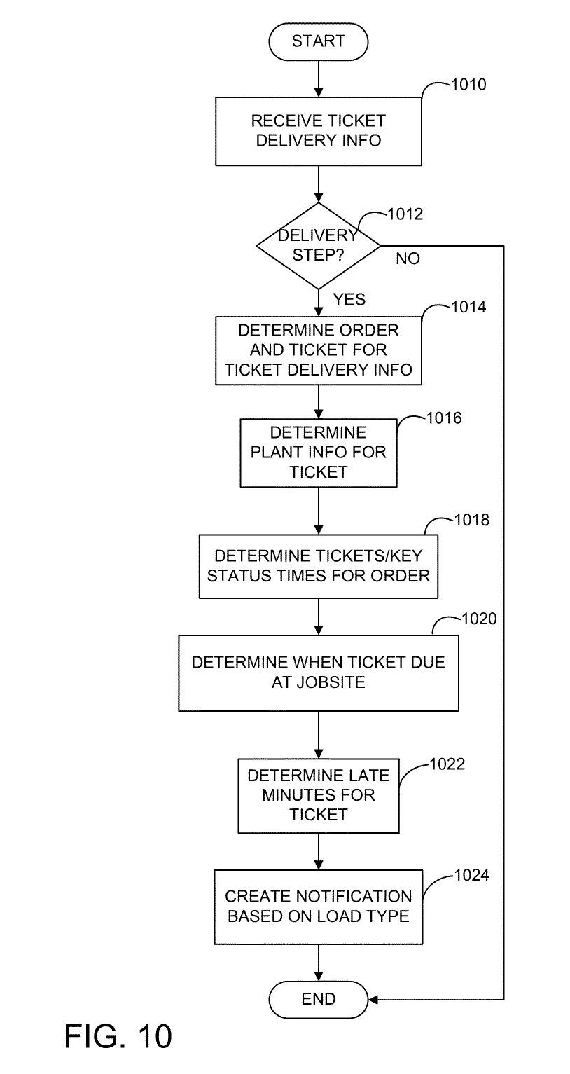

FIG. 10 shows a process for determining whether a truck is going to arrive at the jobsite late, and if so, creating a late truck notification to alert crew at the jobsite of the delay. In some embodiments, the process shown in FIG. 10 is executed each time a ticket delivery step is updated. In act 1010, ticket delivery information is received. For example, an indication that a new ticket has shipped may be received in data repository 114. The process then proceeds to act 1012, where it is determined whether the ticket delivery step is one in which the late truck notification process of FIG. 10 is applicable. If it is determined that the ticket delivery step is not applicable, the process ends. Otherwise, if it is determined that the ticket delivery step is one in which the process should be executed, the process proceeds to act 1014, where the order and ticket for the ticket delivery step is determined. As discussed above, in some embodiments TicketDeliveryStep may be an entity having sub-entities Ticket and DeliveryStep. The data stored in the sub-entities may be used to determine the order and ticket for the ticket delivery step in act 1014.

The process then proceeds to act 1016, where plant information for the ticket is determined. For example, the plant information may include a plant ID and a time zone offset for the plant. The process then proceeds to act 1018, where the tickets and key status times for the order are determined, for example, using the processes described in FIGS. 6-8. The process then proceeds to act 1020, where the time when the ticket is due at the jobsite (e.g., when the load associated with the ticket is expected to be delivered) is determined. In some embodiments, the time the ticket is due at the jobsite is determined as either the adjusted planned on job time for the ticket or the last of the end pour times for previous tickets, whichever time is greater.

The process then proceeds to act 1022, where the lateness (e.g., in minutes) of the ticket is determined based on a comparison of the forecasted/theoretical on job time for the ticket and the determined time when the ticket is due at the jobsite. In some embodiments, the determined lateness of the ticket to the jobsite may be compared to a threshold value (e.g., 5 minutes), and if the determined lateness is less than the threshold value, the process of FIG. 10 may exit without creating a late truck notification. Otherwise, if the determined lateness is greater than the threshold value, the process proceeds to act 1024, where a notification is created. In some embodiments, the notification may be created based, at least in part, on the load type. For example, if the load is a plus load, a plus load notification may be created, and if the load is not a plus load, a late truck notification may be created.

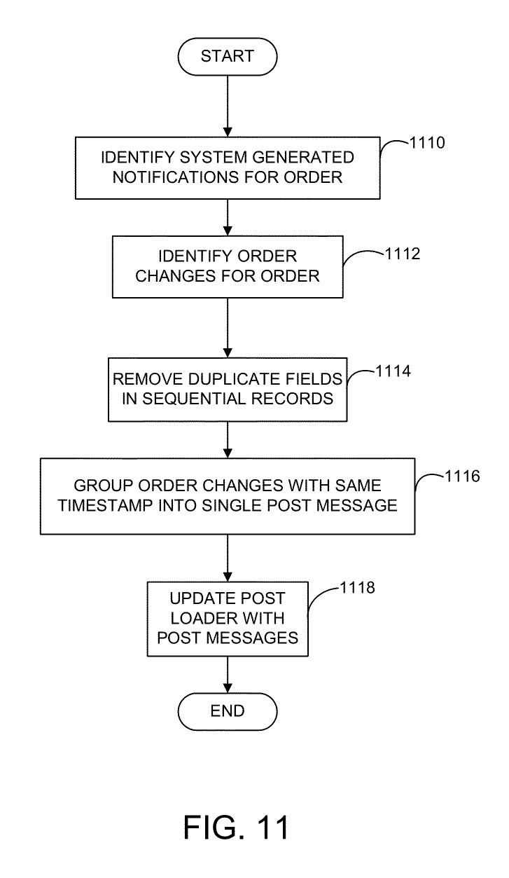

Some embodiments provide a social stream for an application that includes posts and comments related to tracking jobs and/or orders for construction material delivery. Some messages included in the social stream may be system-generated messages (e.g., notifications), whereas other messages may be user-generated messages. FIG. 11 shows an illustrative process for ensuring that system-generated messages are kept up to date in the social stream. In some embodiments, the process of FIG. 11 may be executed each time an order or ticket is received as incoming data.

In act 1110, all system-generated notifications are identified. In some embodiments, certain types of system-generated notifications (e.g., change order notifications) may be ignored in act 1110. The process proceeds to act 1112, where order changes for an order are identified. The process then proceeds to act 1114, where data in fields for sequential message records are compared, and fields with duplicate data in sequential message records are removed (e.g., only unique data in sequential message records is kept). The process then proceeds to act 1116, where all changes associated with the same timestamp are grouped together into a single post message. The process then proceeds to act 1118, where the message is loaded into a post loader for merging the message into the post table for display in the social stream.

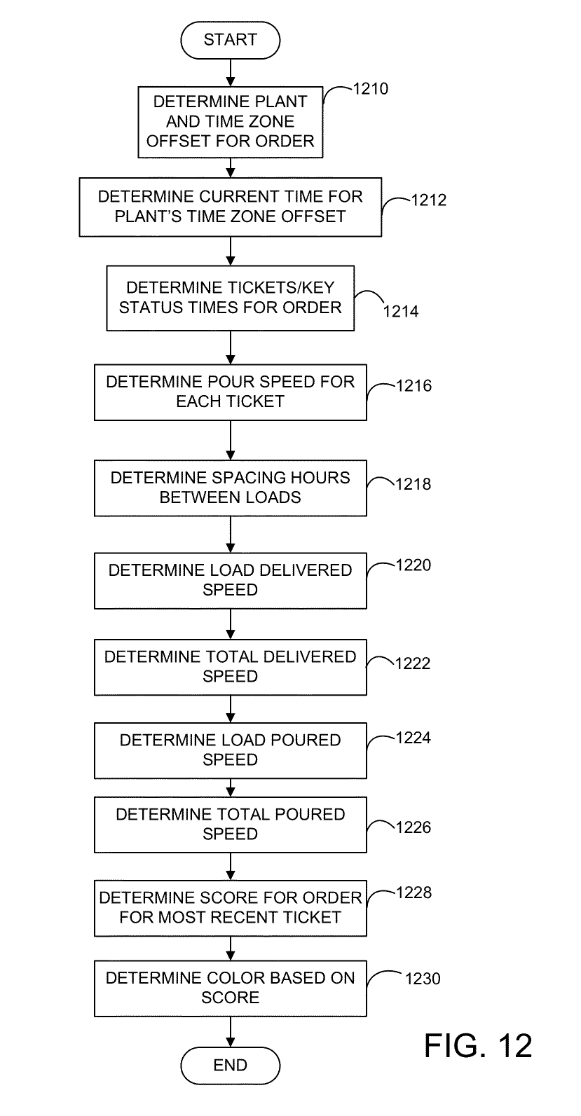

FIG. 12 shows an illustrative process for determining an order pour speed in accordance with some embodiments. In act 1210, the plant and time zone offset for the order is determined. The process then proceeds to act 1212, where the current time for the plant's time zone offset is determined. The process then proceeds to act 1214, where the tickets and key status times for the order are determined, for example, using the processes in FIGS. 6-8.

The process then proceeds to act 1216, where the pour speed for each ticket is determined. In some embodiments, the pour speed for each ticket may be determined as follows:
1) Determine the number of hours the truck was on the job
2) Determine the number of hours the truck was pouring on the job
3) Determine the load pour speed by dividing the load volume by the number of hours the truck was pouring on the job
4) Determine the running volume for arriving at the jobsite.

The process then proceeds to act 1218, where the spacing hours between loads arriving at the job is determined. The process then proceeds to act 1220, where the load delivered speed is determined. In some embodiments, the load delivered speed is determined by dividing the load volume by the load spacing hours. The process then proceeds to act 1222, where the total delivered speed is determined. In some embodiments, the total delivered speed is determined by dividing the running volume by the sum of the load spacing hours of previous loads.

The process then proceeds to act 1224, where the load poured speed is determined. In some embodiments, the load poured speed is determined by dividing the load volume by the load pouring hours. The process then proceeds to act 1226, where the total poured speed is determined. In some embodiments, the total poured speed is determined by dividing the running volume by the sum of the load pouring hours of previous loads.

The process then proceeds to act 1228, where a score for the order for the most recent ticket at the jobsite is determined. In some embodiments, the score is determined as 100*(total poured speed−ordered speed)/ordered speed.

The process then proceeds to act 1230, where the color of a Jobs tile displayed by the application is determined based on the score. In some embodiments, if the score ≧−10, the color is green, if the score is between −10 and 50, the color is yellow, and if the score >50, the color is red. Any other suitable colors or criteria for assigning a color based on the score may be used, and embodiments are not limited in this respect.

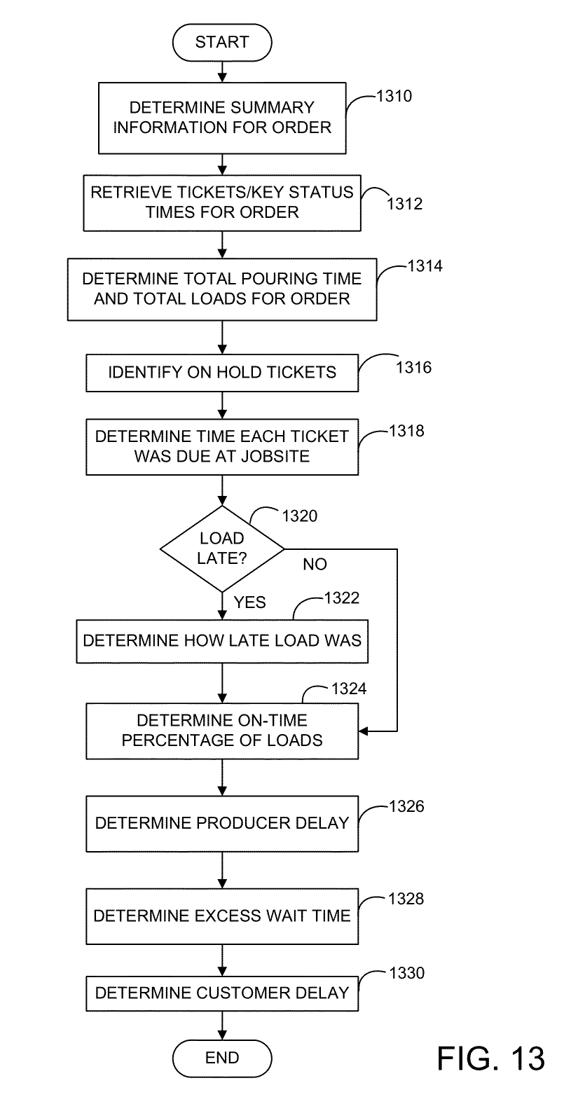

In some embodiments, when an order is associated with a pour state of “complete,” a summary for the order is aggregated and stored in data repository 114. FIG. 13 shows an illustrative process for aggregating data for a summary of an order in accordance with some embodiments. In act 1310, summary information for the order is determined. In some embodiments, the summary information may include order volume, on job time, and spacing minutes for delivery of material to the jobsite. The process then proceeds to act 1312, where tickets and key status times for the order are determined using, for example, the processes shown in FIGS. 6-8. The process then proceeds to act 1314, where the total pouring time and total loads for the order are determined.

The process then proceeds to act 1316, where all tickets that were on hold immediately prior to being allocated are identified. The process then proceeds to act 1318, where the time each ticket was due at the jobsite is determined. In some embodiments, the time each ticket was due at the jobsite is determined as either the adjusted planned on job time for the ticket or the last of the end pour times for previous tickets for the order, whichever is greater.

The process then proceeds to act 1320, where it is determined whether the load was delivered late to the jobsite. In some embodiments, determining whether the load was delivered late comprises determining that the load was not late, when the ticket is for a plus load, if the ticket was on hold prior to being allocated, or if the ticket arrived at the jobsite before it was due. However, if the ticket arrived at the jobsite after it was due, it is determined that the load was late. If it is determined that the load was late, the process proceeds to act 1322, where the lateness of the load is determined. In some embodiments, the lateness of the load is determined as the difference between the time when the ticket arrived at the jobsite and the time when the ticket was due at the jobsite.

The process then proceeds to act 1324, where the percentage of on-time loads is determined. In some embodiments, the percentage of on-time loads is determined as (1−number of late loads)/total loads for the order. The process then proceeds to act 1326, where the producer delay for the order is determined. In some embodiments the producer delay is determined as the sum of the lateness of all late loads for the order.

The process then proceeds to act 1328, where the excess wait time for each ticket of the order is determined. In some embodiments, the pouring time for a ticket is determined as the difference between the on job time of a ticket and the end pour time of the ticket, and the excess wait time is determined as difference between the pouring time for the ticket and the planned pouring time for the ticket, which is a value greater than zero. The process then proceeds to act 1330, where the customer delay is determined. In some embodiments, the customer delay is determined as the sum of the excess wait times for all tickets of the order.

The processes described above for extracting/loading incoming data, aggregating data, and providing system-generated notifications may be executed by cloud-based components (e.g., stored procedures) of the system in any suitable time intervals and without requiring a request for data from an application executing on a client device. Additional processes described below relate to portions of a user interface for an application programmed with data calls that can be mapped to stored procedures for querying data stored in data repository 114. The data calls are used to update user interface elements represented on web pages of the application presented on the client device. For example, an application may be associated with a script that includes pages with elements and data calls, as discussed above in connection with the D3 platform described in FIG. 2.

Applications programmed in accordance with the techniques described herein can provide a wide range of functionality that enables users to probe information stored on data repository 114 regarding the delivery of construction materials to jobsites. For example, in some embodiments, an application may be configured to display a user interface element representing a market summary, which describes a breakdown of the production for a user over a given time period. A user may have access to any suitable number of markets, and access to particular markets may be limited based on the user's access level.

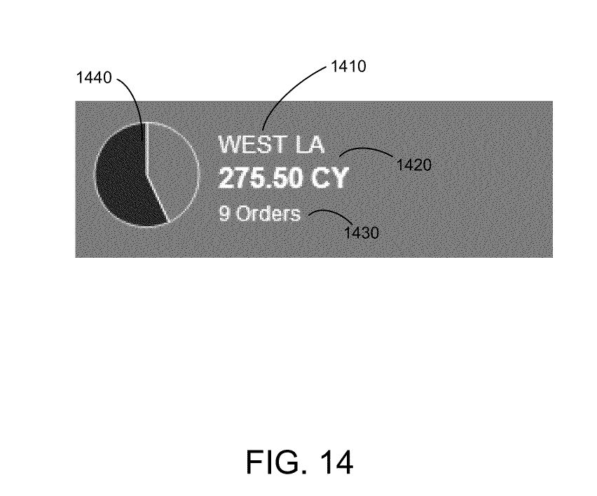

FIG. 14 shows an example of a user interface (UI) element providing market summary information representing a summary of the production for a market area. The UI element includes a tagline 1410, defined by the setup of the supplier, which is a market area combining any number of plants. The UI element also include a title 1420, which is the total amount of construction material ordered for the time period that is not cancelled. The UI element also includes a subtitle 1430, which describes the total number of orders for the time period, including cancelled orders. The UI element also includes a pie chart 1440, which indicates the percent of construction material poured (or ticketed for Free on Board (FOB)) orders of the total volume ordered.

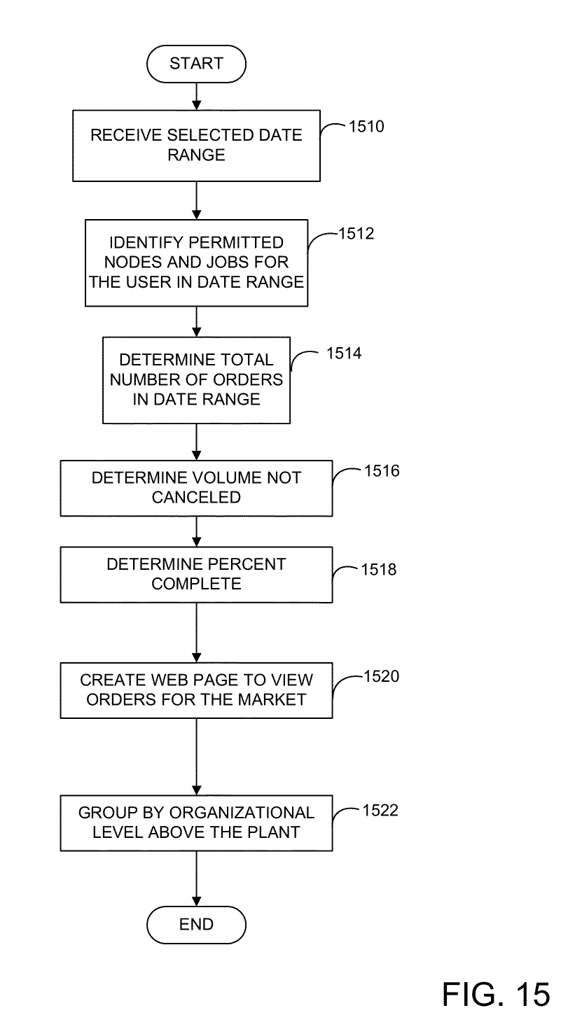

FIG. 15 shows an illustrative process for updating the data presented on the UI element shown in FIG. 14. In act 1510, a selected date range for displaying a market summary is received. The process then proceeds to act 1512, where permitted nodes and permitted jobs for the user issuing the request in the received date range are identified. As discussed above, in some embodiments, nodes may be used to restrict users' access to information. For example, internal users may have their access limited by nodes they have access to, whereas external users may have access to all nodes. Nodes which a user has access to are the “permitted nodes” for that user. Additionally, external users may be limited by the jobs they have access to, whereas internal users may have access to all jobs. Jobs which a user has access to are the “permitted jobs” for that user.

The process then proceeds to act 1514, where the total number of orders the user has access to during the time range is determined. The process then proceeds to act 1516, where the total volume ordered and not cancelled during the time range is determined. The process then proceeds to act 1518, where the percent complete is determined. In some embodiments, the percent complete is determined as the sum of the poured (or ticked) ordered volume divided by the ordered volume. The process then proceeds to act 1520, where a web page (e.g., a URL for a web page) is created to view all orders for the market. The process proceeds to act 1522, where the orders are grouped by organizational level above the plant.

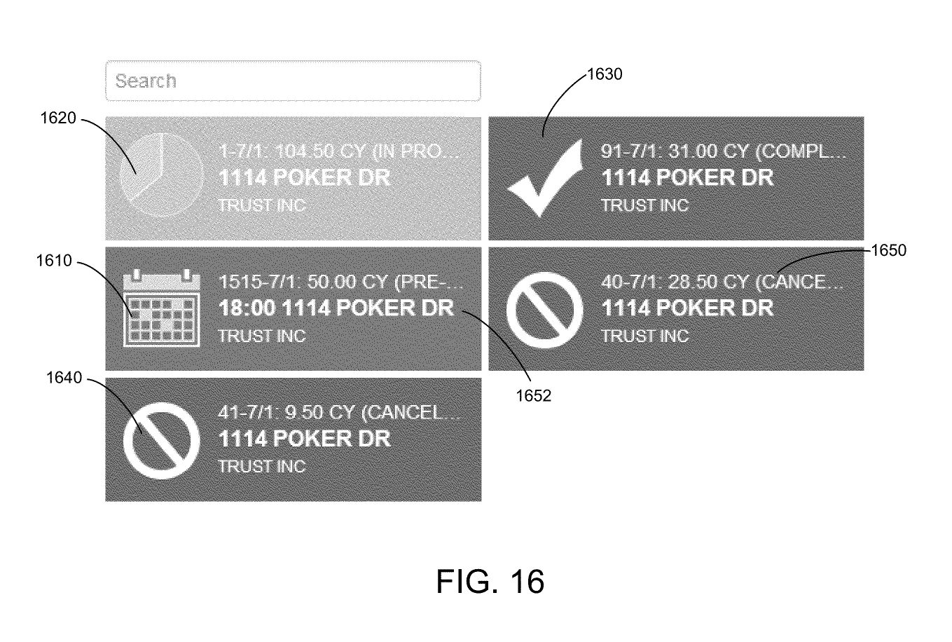

FIG. 16 shows an example of a UI element providing order information for all orders a user has access to. Each tile in the UI element represents an order for a selected market. Statuses for orders are represented in the UI element by the use of different icons. As shown, a pre-pour order 1610, which has not yet started (e.g., no ticket activity) is represented by a calendar icon. An in-progress order 1620, which has some ticket activity, is represented by a pie chart icon, with the pie chart icon representing the total volume poured divided by the volume ordered. A complete order 1630, which has finished pouring the ordered amount, if represented by a checkmark icon. A cancelled order 1640, which is an order that has been cancelled for any reason, is represented by a circle with slash icon. An on-hold order (not shown) is an order that has been placed on hold.

Each of the tiles in the UI element of FIG. 16 includes additional information. A tagline 1650 displays the order number from the producer's dispatch system, and includes the order date, total volume, and pour state for the order. A title 1652 displays the time due at the jobsite (for pre-pour orders) and the jobsite address. In some embodiments, the color of the tile for each order may be determined based on the type of order and/or a pour speed associated with the order. For example, pre-pour orders may be shown in green for firm orders and yellow for will call orders. On-hold orders may be displayed in red. For in-progress or completed orders, the order's most recent pour speed calculation may be compared to the ordered speed, and orders within 10% of the ordered speed may be displayed using green tiles, between 60% and 90% may be displayed using yellow tiles, and less than 60% may be displayed using red tiles. Other colors and/or thresholds may alternatively be used, and embodiments are not limited in this respect.

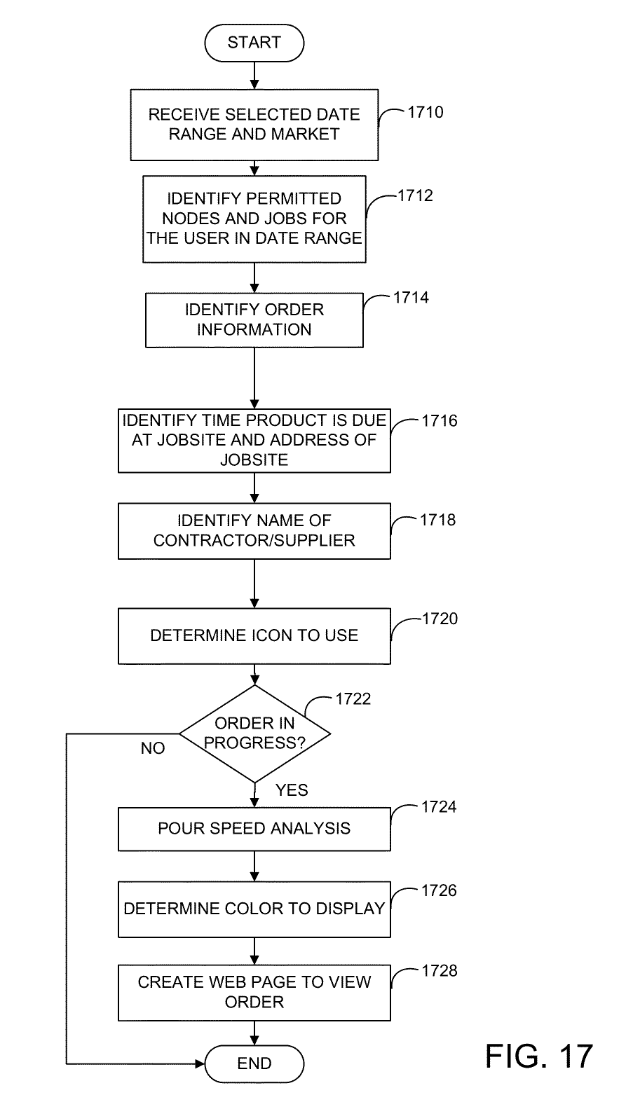

FIG. 17 shows an illustrative process for updating the data presented on the UI element shown in FIG. 16. In act 1710, a selected date range and market is received. The process then proceeds to act 1712, where permitted nodes and jobs for the user in the selected data range are identified. The process then proceeds to act 1714, where order information for all orders is identified. In some embodiments, the order information includes order number, order date, total volume, and pour state. The process then proceeds to act 1716, where the time the construction material is due at the jobsite and the address of the jobsite is determined. The process then proceeds to act 1718 where the name of the contractor (internal user) or supplier brand name (contractor) for each order is identified. The process then proceeds to act 1720, where the appropriate icon to use for each order is determined based on the type of the order. The process then proceeds to act 1722, where for each order it is determined whether the order is in progress. If it is determined that the order is in progress, the process proceeds to act 1724, where a pour speed analysis is performed. In some embodiments, the pour speed analysis comprises dividing the current pour speed by the planned pour speed. The process then proceeds to act 1726, where a color for the in-progress order is determined based on the pour speed analysis. The process then proceeds to act 1728, where a web page is created to view the order.

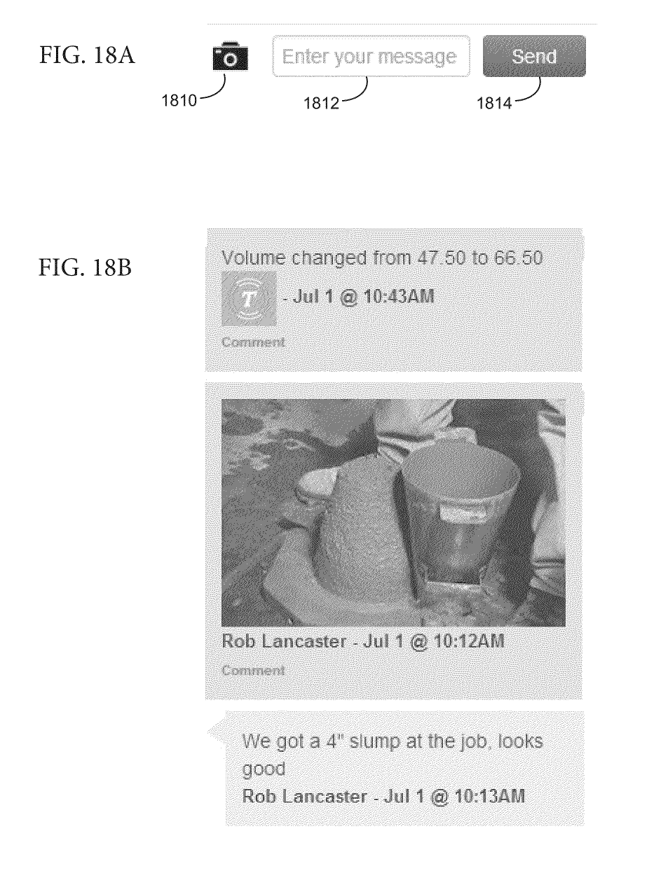

As discussed above, some applications may include a social stream that provides users with notifications of events during the delivery of construction materials to a jobsite, and enables users to add posts and comments to the social stream. FIGS. 18A and 18B show illustrative UI elements for a social stream that may be used in accordance with some embodiments. Camera icon 1810, when selected, enables a user to upload a picture to the social stream. Typing a message in box 1812 and selecting send 1814 allows a user to post a comment into the social stream. FIG. 18B shows a screenshot of an illustrative social stream.

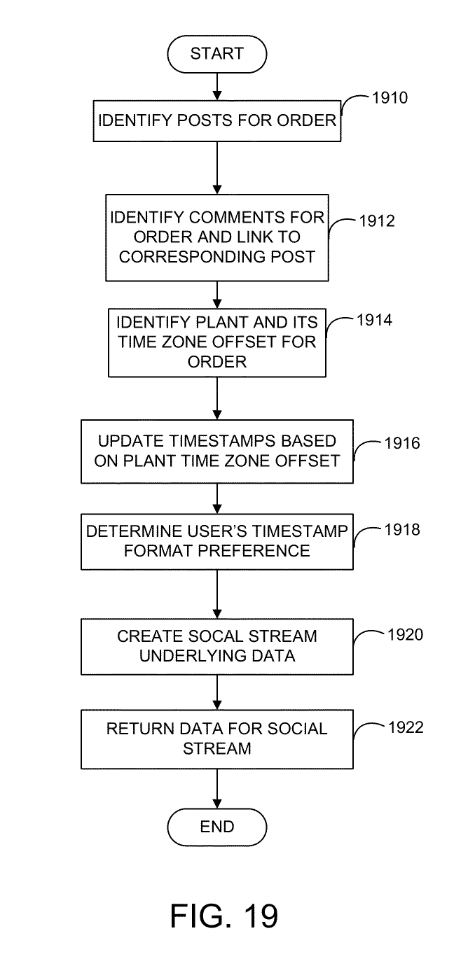

FIG. 19 shows an illustrative process for updating a social stream with system-generated and user-generated posts in accordance with some embodiments. In act 1910, all posts for an order are identified. The process proceeds to act 1912, where comments for the order are identified and linked to the original post to which they pertain. The process then proceeds to act 1914, where the plant and its time zone offset for the order are identified. The process then proceeds to act 1916, where the timestamps for the posts/comments are updated based on the time zone offset for the plant. The process then proceeds to act 1918, where the user's timestamp preference is determined.

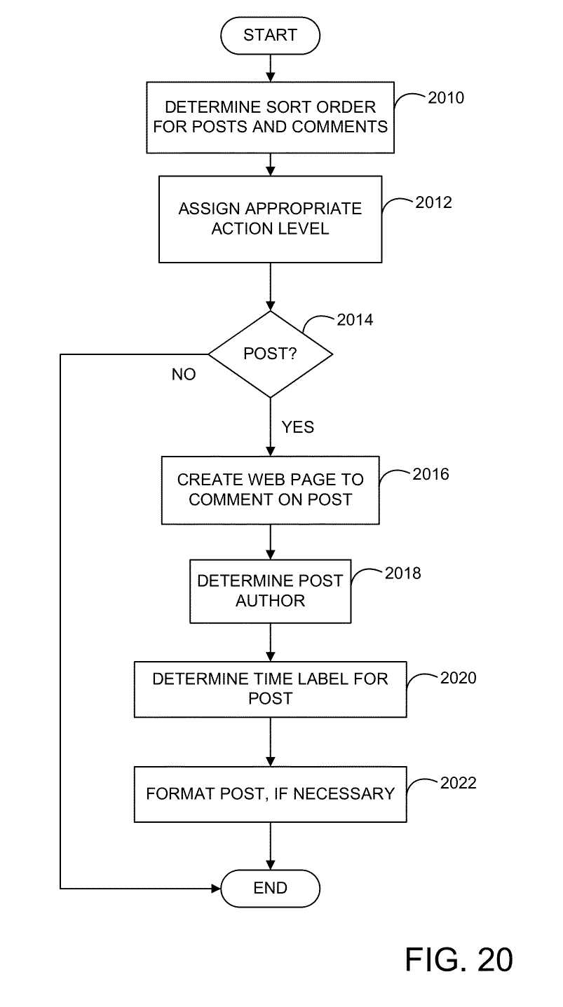

The process then proceeds to act 1920, where the underlying data for the social stream is created. FIG. 20 shows an illustrative process for creating social stream data. In act 2010, a sort order to display posts and comments is determined, making sure posts appear above any comments. The process proceeds to act 2012, where an appropriate action level is assigned based on whether the message is a post or comment. The process then proceeds to act 2014, where it is determined whether the message is a post. If the message is a post, the process proceeds to act 2016, where a URL is created to enable comments to be add to the post. The process then proceeds to act 2018, where the author of the post is determined. If the post was automated, the logo of the application generating the post may be displayed. If the post was user-generated, the name of the user may be displayed. The process then proceeds to act 2020, where a time label is determined from the timestamp of the post. The process then proceeds to act 2022, where the time label is formatted, if necessary, in accordance with the user's preferred timestamp format. If the post is a photograph, the photograph may be formatted to be an image. Otherwise, the post may be formatted using the message details.

Returning to the process of FIG. 19, the process then proceeds to act 1922, where the social stream data is returned to the client device for display. In some embodiments, the returned data may include action level, message details, and name/time label.

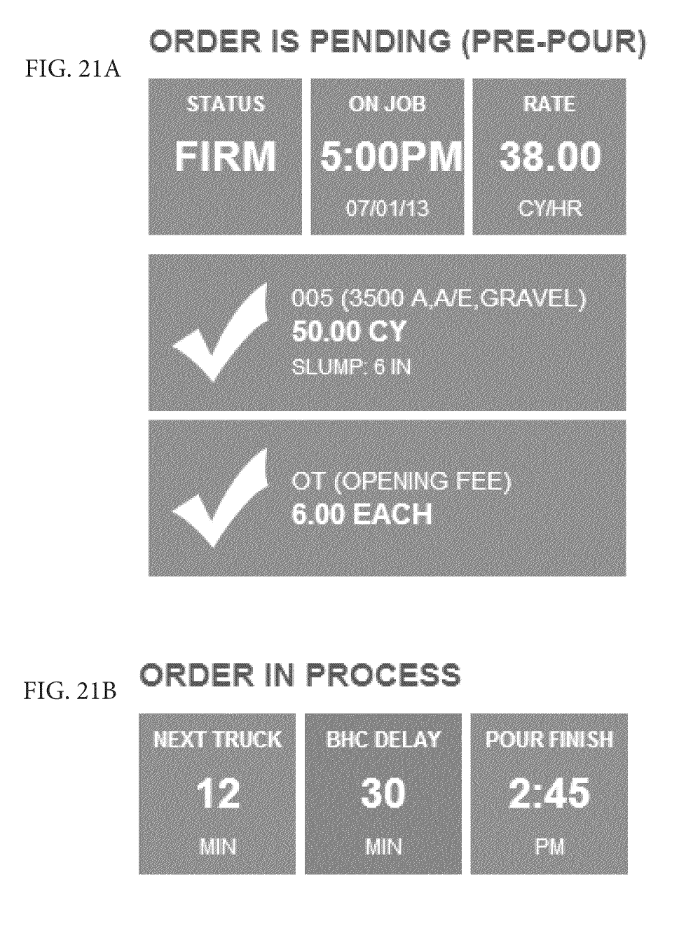

FIGS. 21A and 21B show UI elements for providing a current snapshot of an order. FIG. 21A illustrates a UI element for a pre-pour order, and FIG. 21B illustrates a UI element for an in-progress order. As shown in FIG. 21B, after an order begins, the UI element displays information about material being delivered to the jobsite and how the pour is going so far.

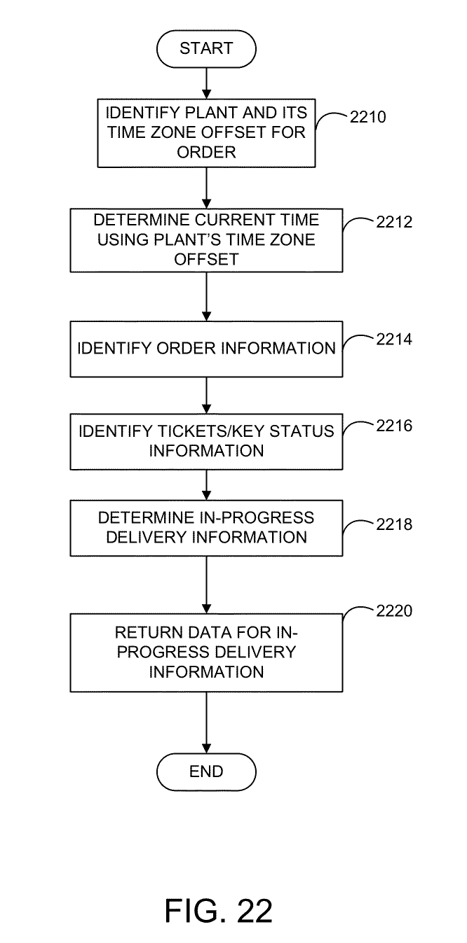

FIG. 22 show an illustrative process for updating the data displayed in FIGS. 21A and 21B. In act 2210, the plant and its time zone offset for the order are determined. The process proceeds to act 2212, where the current time is determined based on the plant's time zone offset. The process then proceeds to act 2214, where order information for the order is identified. In some embodiments, the order information may include total loads, volume, and theoretical end pour for the order. The process then proceeds to act 2216, where tickets and key status information for the order are identified using, for example, the processes shown in FIGS. 6-8.

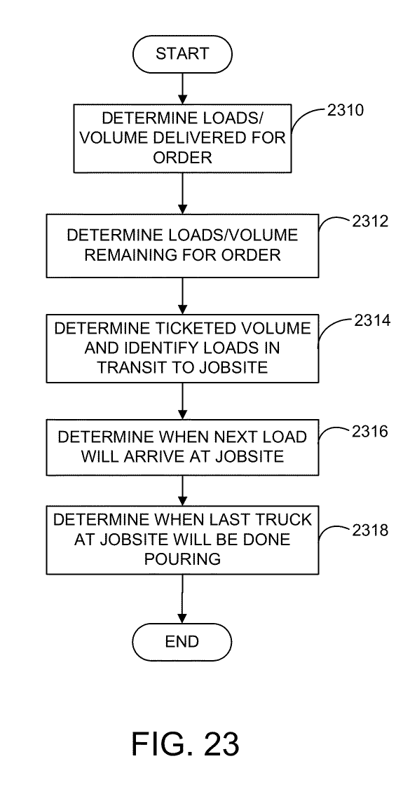

The process then proceeds to act 2218, where in-progress delivery information is determined for an order that is in progress (e.g., the order displayed in FIG. 21B). FIG. 23 shows an illustrative process for determining in-progress delivery information in accordance with some embodiments. In act 2310 loads and volume delivered for an order are determined. The process proceeds to act 2312, where loads and volume remaining for the order is determined. The process then proceeds to act 2314, where the ticketed volume is determined and loads in transit to the jobsite are identified. The process then proceeds to act 2316, where it is determined when the next load will arrive at the jobsite. In some embodiments, the time when the next truck will arrive at the jobsite is determined as either the adjusted planned on job time for the ticket associated with the load or the last of the end pour times for previous tickets for the order, whichever is greater. The process then proceeds to act 2318, where it is determined when the last truck at the jobsite will be done pouring.

Returning to the process of FIG. 22, the process proceeds to act 2220, where the data for in-progress delivery information is returned to the client device for display.

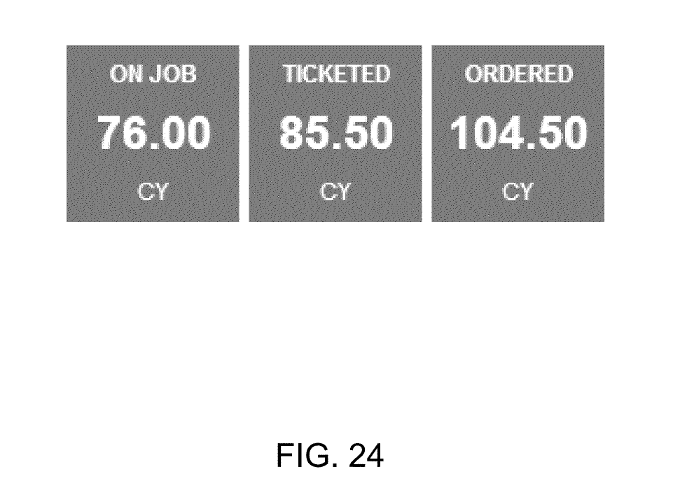

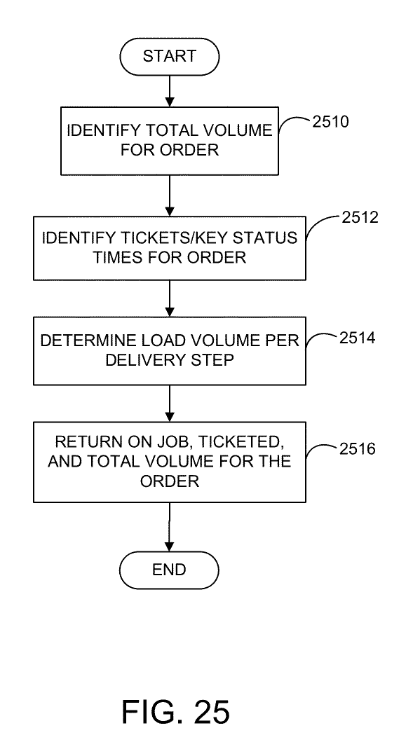

FIG. 24 shows an illustrative UI element describing how much construction material is in various stages of delivery. FIG. 25 shows an illustrative process for updating the data displayed on the UI element of FIG. 24. In act 2510, the total volume for an order is determined. The process proceeds to act 2512, where tickets and key status information for the order are identified using, for example, the processes shown in FIGS. 6-8. The process then proceeds to act 2514, where the load volume for all active tickets is determined based on current delivery step of the ticket. The process then proceeds to act 2516, where on job, ticketed, and total volume data for the order is returned to the client device for display.

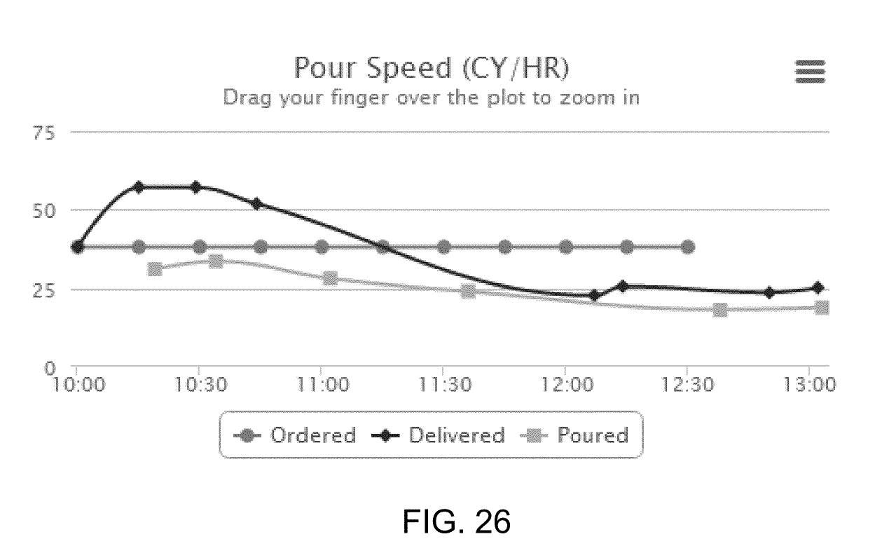

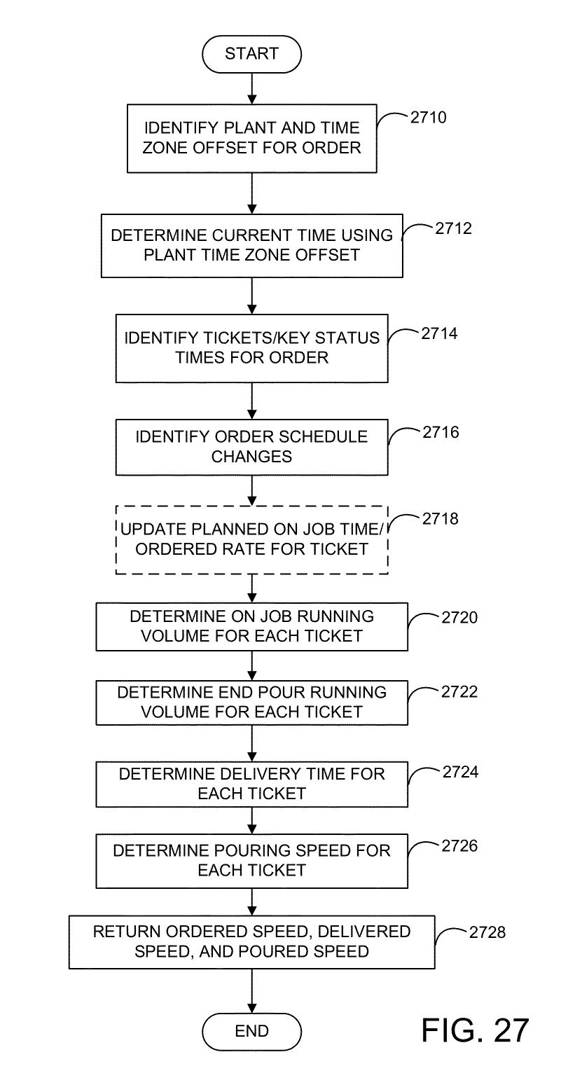

FIG. 26 shows an illustrative UI element for displaying information about in-progress and completed orders. In particular, FIG. 26 shows a screenshot of a pour speed chart for a completed order. FIG. 27 shows an illustrative process for updating the data for the pour speech chart of FIG. 26. In act 2710, the plant and time zone offset of the plant for the order is identified. The process then proceeds to act 2712, where the current time is determined using the plant's time zone offset. The process then proceeds to act 2714, where tickets and key status information for the order are identified using, for example, the processes shown in FIGS. 6-8. The process then proceeds to act 2716, where all the order schedule changes for the order are identified.

The process then proceeds to act 2718, where the planned on job time and ordered rate for each ticket for the order is optionally updated if there were any different spacing minutes or ordered rate differences when the ticket was allocated. The process then proceeds to act 2720, where the job running volume for each ticket is determined. In some embodiments, the job running volume for a ticket is determined by adding the on volume for all the loads that arrived at the jobsite before each ticket. The process then proceeds to act 2722, where the end pour running volume for each ticket is determined. In some embodiments, the end pour running volume is determined by adding the on volume for all the loads that finished pouring before each ticket.

The process then proceeds to act 2724, where the delivery speed for each ticket is determined. In some embodiments, the delivery speed is determined by determining when the first load arrived at the job (time 0), calculating the delivery hours for the load as the difference between its on job time and time 0, and dividing the ticket's running on job volume by the delivery hours for the load. In some embodiments, the delivery speed is smoothed to be no more than 1.5 times the ordered rate.

The process then proceeds to act 2726, where the pouring speed for each ticket is determined. In some embodiments, the pouring speed is determined by determining when the first load arrived at the job (time 0), calculating the pouring hours for the load as the difference between the end pour time and time 0, and dividing the ticket's running poured volume by the pouring hours. In some embodiments the pouring speed for a ticket may be smoothed to be no more than 1.5 times the ordered rate.

The process then proceeds to at 2728, where the ordered speed, delivered speed, and poured speed is returned to the client device for display. In some embodiments, the ordered speed is the planned on job time, the delivered speed is the actual on job time, and the pouring speed is the actual end pour time.

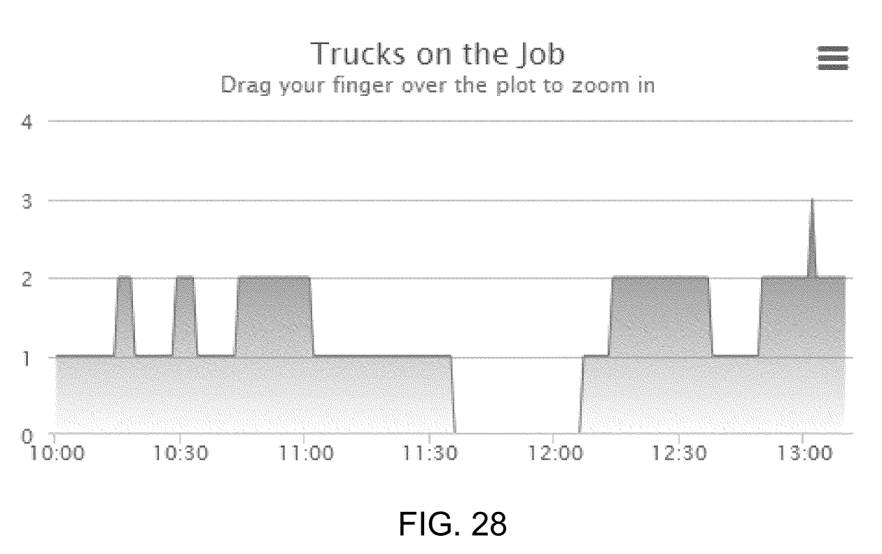

FIG. 28 shows an illustrative UI element for displaying information about a delivery timeline of construction material to a jobsite. In particular, FIG. 28 shows a “Trucks on the Job” graph, which displays how many trucks were being used at throughout the delivery process. This information may be used by customers and producers to evaluate times when more or less trucks on the job may have improved the efficiency of the construction material delivery.

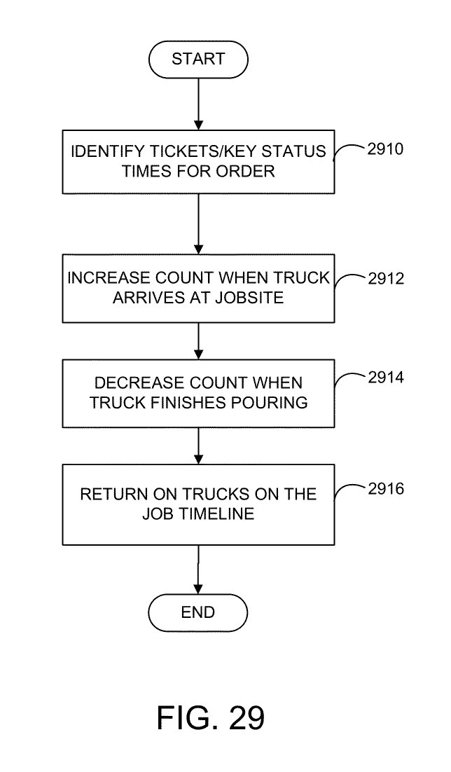

FIG. 29 shows an illustrative process for updating the data for the graph shown in FIG. 28. In act 2910, tickets and key status information for the order are identified using, for example, the processes shown in FIGS. 6-8. The process proceeds to act 2912, where a count is increased when a truck arrives at the jobsite. The process then proceeds to act 2914, where the count is decreased when a truck finishes pouring. The process then proceeds to act 2916, where the count data as a function of time during the job is returned to the client device for display.

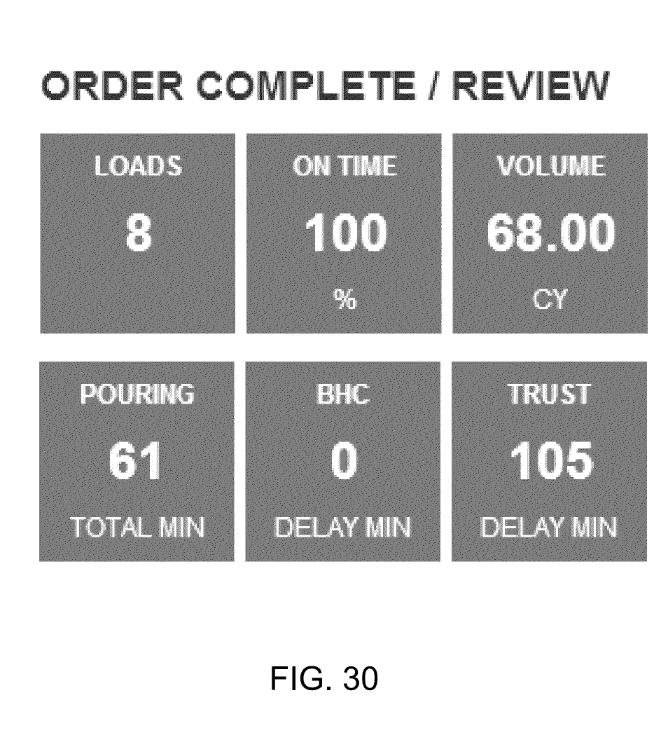

FIG. 30 shows an illustrative UI element for displaying information about a completed order. The data displayed in the UI element of FIG. 30 may be returned via an aggregated table for completed orders, as described above in connection with FIG. 13. The UI element of FIG. 30 may also show the pour speed and trucks on the job graphs described in connection with FIGS. 26 and 28.

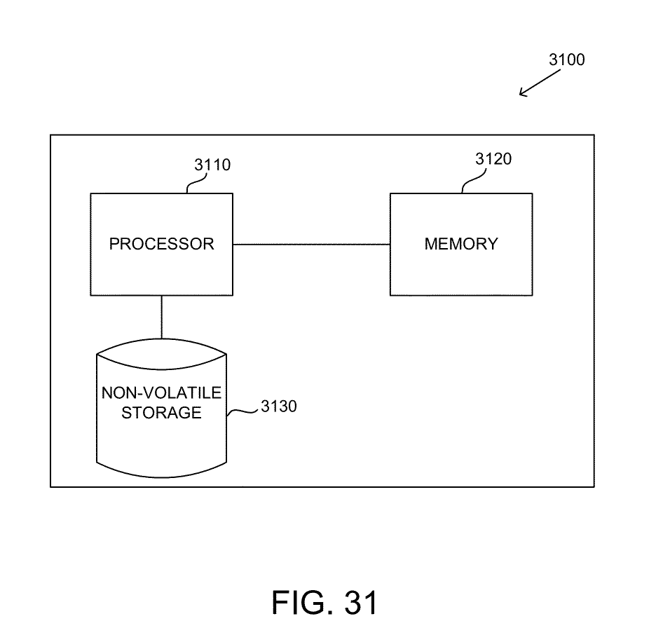

An illustrative implementation of a computer system 3100 that may be used in connection with any of the embodiments described herein is shown in FIG. 31. The computer system 3100 may include one or more processors 3110 and one or more computer-readable non-transitory storage media (e.g., memory 3120 and one or more non-volatile storage media 3130). The processor 3110 may control writing data to and reading data from the memory 3120 and the non-volatile storage device 3130 in any suitable manner, as the embodiments described herein are not limited in this respect. To perform any of the functionality described herein, the processor 3110 may execute one or more instructions stored in one or more computer-readable storage media (e.g., the memory 3120), which may serve as non-transitory computer-readable storage media storing instructions for execution by the processor 3110.

The above-described embodiments can be implemented in any of numerous ways. For example, the embodiments may be implemented using hardware, software or a combination thereof. When implemented in software, the software code can be executed on any suitable processor or collection of processors, whether provided in a single computer or distributed among multiple computers. It should be appreciated that any component or collection of components that perform the functions described above can be generically considered as one or more controllers that control the above-discussed functions. The one or more controllers can be implemented in numerous ways, such as with dedicated hardware, or with general purpose hardware (e.g., one or more processors) that is programmed using microcode or software to perform the functions recited above.

In this respect, it should be appreciated that one implementation of the embodiments comprises at least one non-transitory computer-readable storage medium (e.g., a computer memory, a USB drive, a flash memory, a compact disk, a tape, etc.) encoded with a computer program (i.e., a plurality of instructions), which, when executed on a processor, performs the above-discussed functions of the embodiments. The computer-readable storage medium can be transportable such that the program stored thereon can be loaded onto any computer resource to implement the embodiments discussed herein. In addition, it should be appreciated that the reference to a computer program which, when executed, performs the above-discussed functions, is not limited to an application program running on a host computer. Rather, the term computer program is used herein in a generic sense to reference any type of computer code (e.g., software or microcode) that can be employed to program a processor to implement the above-discussed embodiments.

Various aspects of embodiments may be used alone, in combination, or in a variety of arrangements not specifically discussed in the embodiments described in the foregoing and are therefore not limited in their application to the details and arrangement of components set forth in the foregoing description or illustrated in the drawings. For example, aspects described in one embodiment may be combined in any manner with aspects described in other embodiments.

Also, embodiments may be implemented as one or more methods, of which an example has been provided. The acts performed as part of the method(s) may be ordered in any suitable way. Accordingly, embodiments may be constructed in which acts are performed in an order different than illustrated, which may include performing some acts simultaneously, even though shown as sequential acts in illustrative embodiments.

The phraseology and terminology used herein is for the purpose of description and should not be regarded as limiting. The use of “including,” “comprising,” “having,” “containing”, “involving”, and variations thereof, is meant to encompass the items listed thereafter and additional items.

Having described several embodiments in detail, various modifications and improvements will readily occur to those skilled in the art. Such modifications and improvements are intended to be within the spirit and scope of the invention. Accordingly, the foregoing description is by way of example only, and is not intended as limiting.

What is claimed is:

1. A system for tracking delivery of construction material from at least one supplier location to a construction jobsite, the system comprising:
a server computer including at least one processor programmed to:
determine a forecasted schedule for an order to deliver the construction material to the construction jobsite;
receive, by a cloud-based storage device, during delivery of the construction material to the construction jobsite, an electronic ticket indicating a delivery status of a load of the construction material to the construction jobsite;
update the forecasted schedule based, at least in part, on ticket information associated with the electronic ticket to produce an updated schedule; and
provide an indication of the updated schedule to a client device.

2. The system of claim 1, wherein the at least one processor is further programmed to receive a request for the indication of the updated schedule from the client device and wherein providing the indication of the updated schedule to the client device comprises providing the indication of the updated schedule to the client device in response to receiving the request from the client device.

3. The system of claim 1, wherein determining a forecasted schedule for delivery of the construction material comprises:
determining a total number of loads for the order of the construction material;
determining delivery parameters for each of the loads in the order; and
determining the forecasted schedule based, at least in part, on the total number of loads and the delivery parameters for each of the loads in the order.

4. The system of claim 1, wherein the ticket information includes a current delivery step of the load and a time associated with the current delivery step, and wherein the at least one processor is further programmed to:
determine an adjusted planned on job time for the load based, at least in part, on the current delivery step of the load and the time associated with the current delivery step, and wherein updating the forecasted schedule comprises updating the forecasted schedule based, at least in part, on the determined adjusted planned on job time for the load.

5. The system of claim 4, wherein determining the adjusted planned on job time for the load comprises:
determining, based on the current delivery step of the load, whether the load has been delivered to the construction job site;
determining the adjusted planned on job time for the load as the time associated with the current delivery step when it is determined that the load has been delivered to the construction job site; and
determining the adjusted planned on job time for the load based, at least in part, on delivery statistics associated with a supplier location of the load when it is determined that the load has not been delivered to the construction job site.

6. The system of claim 1, wherein the forecasted schedule specifies theoretical on job times for each of a plurality of loads in the order, and wherein the at least one processor is further programmed to:
determine based on the ticket information specified for each of a plurality of electronic tickets associated with the order and stored by the cloud-based storage device, an adjusted planned on job time for each of the plurality of loads in the order;
determine slack for the order based on a comparison of the adjusted planned on job times and the theoretical on job times; and
wherein updating the forecasted schedule comprises updating the forecasted schedule based, at least in part, on the determined slack for the order.

7. The system of claim 1, wherein updating the forecasted schedule based, at least in part, on the determined slack for the order comprises adding the determined slack to the theoretical on job times for loads in the order that have not left a supplier location.

8. The system of claim 1, wherein providing an indication of the updated schedule to the client device comprises issuing a notification to the client device, wherein the notification is selected from the group consisting of a plus load notification, a first truck notification, and a late truck notification.

9. The system of claim 1, wherein providing an indication of the updated schedule to the client device comprises updating a social stream accessible by the client device with information about the updated schedule for the order.

10. The system of claim 1, wherein the at least one processor is further programmed to:
create, based, at least in part, on ticket information for a plurality of electronic tickets associated with the order and stored by the cloud-based storage device, an electronic audit trail for the delivery of construction material from the at least one supplier location to the construction jobsite, wherein the electronic audit trail includes information about a delivery timeline for the order.

11. The system of claim 1, wherein providing an indication of the updated schedule to the client device comprises providing a web page including the indication of the updated schedule to the client device.

12. A method of tracking delivery of construction material from at least one supplier location to a construction jobsite, the system comprising:
determining, by at least one computer processor, a forecasted schedule for an order to deliver the construction material to the construction jobsite;
receiving, by a cloud-based storage device, during delivery of the construction material to the construction jobsite, an electronic ticket indicating a delivery status of a load of the construction material to the construction jobsite;
updating the forecasted schedule based, at least in part, on ticket information associated with the electronic ticket to produce an updated schedule; and
providing an indication of the updated schedule to a client device.

13. The method of claim 12, further comprising:
receiving a request for the indication of the updated schedule from the client device and wherein providing the indication of the updated schedule to the client device comprises providing the indication of the updated schedule to the client device in response to receiving the request from the client device.

14. The method of claim 12, wherein determining a forecasted schedule for delivery of the construction material comprises:
determining a total number of loads for the order of the construction material;
determining delivery parameters for each of the loads in the order; and
determining the forecasted schedule based, at least in part, on the total number of loads and the delivery parameters for each of the loads in the order.

15. The method of claim 12, wherein the ticket information includes a current delivery step of the load and a time associated with the current delivery step, and wherein the method further comprises:
determining an adjusted planned on job time for the load based, at least in part, on the current delivery step of the load and the time associated with the current delivery step, and wherein updating the forecasted schedule comprises updating the forecasted schedule based, at least in part, on the determined adjusted planned on job time for the load.

16. The method of claim 15, wherein determining the adjusted planned on job time for the load comprises:
determining, based on the current delivery step of the load, whether the load has been delivered to the construction job site;
determining the adjusted planned on job time for the load as the time associated with the current delivery step when it is determined that the load has been delivered to the construction job site; and
determining the adjusted planned on job time for the load based, at least in part, on delivery statistics associated with a supplier location of the load when it is determined that the load has not been delivered to the construction job site.

17. The method of claim 12, wherein the forecasted schedule specifies theoretical on job times for each of a plurality of loads in the order, and wherein the method further comprises:
determining based on the ticket information specified for each of a plurality of electronic tickets associated with the order and stored by the cloud-based storage device, an adjusted planned on job time for each of the plurality of loads in the order;
determining slack for the order based on a comparison of the adjusted planned on job times and the theoretical on job times; and
wherein updating the forecasted schedule comprises updating the forecasted schedule based, at least in part, on the determined slack for the order.

18. The method of claim 12, wherein providing an indication of the updated schedule to the client device comprises issuing a notification to the client device, wherein the notification is selected from the group consisting of a plus load notification, a first truck notification, and a late truck notification.

19. The method of claim 12, wherein providing an indication of the updated schedule to the client device comprises updating a social stream accessible by the client device with information about the updated schedule for the order.

20. A non-transitory computer-readable medium encoded with a plurality of instructions that, when executed by at least one computer processor, perform a method comprising:
determining a forecasted schedule for an order to deliver the construction material to the construction jobsite;
receiving, by a cloud-based storage device, during delivery of the construction material to the construction jobsite, an electronic ticket indicating a delivery status of a load of the construction material to the construction jobsite;
updating the forecasted schedule based, at least in part, on ticket information associated with the electronic ticket to produce an updated schedule; and
providing an indication of the updated schedule to a client device.
